(19) United States
(12) Patent Application Publication
(10) Pub. No.: US 2012/0163472 A1
(43) Pub. Date: Jun. 28, 2012

(54) EFFICIENTLY CODING SCANNING ORDER INFORMATION FOR A VIDEO BLOCK IN VIDEO CODING

(75) Inventors: Joel Sole Rojals, La Jolla, CA (US); Muhammed Zeyd Coban, Carlsbad, CA (US); Yunfei Zheng, Cupertino, CA (US); Marta Karczewicz, San Diego, CA (US)

(73) Assignee: QUALCOMM INCORPORATED, San Diego, CA (US)

(21) Appl. No.: 13/332,300

(22) Filed: Dec. 20, 2011

Related U.S. Application Data
(60) Provisional application No. 61/426,360, filed on Dec. 22, 2010.
(60) Provisional application No. 61/426,426, filed on Dec. 22, 2010.

(51) Int. Cl. H04N 7/26

(52) U.S. Cl. 375/240.24; 375/E07.2

(57) ABSTRACT

An apparatus is disclosed for coding coefficients associated with a block of video data, including a video coder configured to code information that identifies a first scanning order associated with the block if a position of any of one or more of the coefficients within the block, starting with a first coefficient within the block and ending with a last non-zero coefficient within the block according to the first scanning order, and proceeding according to the first scanning order, according to the first scanning order is different than a position of the respective coefficient within the block according to a second scanning order, and avoid coding the information if the position of each of the one or more of the coefficients within the block according to the first scanning order is the same as the position of the respective coefficient within the block according to the second scanning order.

This application claims the benefit of U.S. Provisional Application No. 61/426,360, filed Dec. 22, 2010, and U.S. Provisional Application No. 61/426,426, filed Dec. 22, 2010, the entire contents of each of which are incorporated herein by reference.

### TECHNICAL FIELD

This disclosure relates to video coding, and more particularly, to the coding of syntax information related to coefficients of a video block.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

This disclosure describes techniques for coding coefficients associated with a block of video data during a video coding process, including techniques for coding information that identifies a scanning order associated with the block, i.e., scanning order information for the block. The techniques of this disclosure may improve efficiency for coding of scanning order information for blocks of video data used to code the blocks. In other words, the techniques may improve compression of the scanning order information for the blocks when the scanning order information is coded.

The coding efficiency may be improved by coding scanning order information for a particular block of video data if a position of any of one or more coefficients within the block, starting with a first coefficient within the block according to a scanning order associated with the block and ending with a last non-zero, or “significant,” coefficient within the block according to the scanning order, and proceeding according to the scanning order, according to the scanning order is different than a position of the respective coefficient within the block according to another scanning order. That is, the coding efficiency may be improved by avoiding coding the scanning order information for the block if the position of each of the one or more coefficients within the block according to the scanning order associated with the block is the same as the position of the respective coefficient within the block according to the other scanning order.

In some examples, the other scanning order may include all scanning orders other than the scanning order associated with the block that may have been used to code the block, e.g., all scanning orders other than the scanning order associated with the block that are also used within the corresponding coding system to code blocks of video data. In other words, the coding efficiency may be improved by avoiding coding the scanning order information for the block if the position of each of the one or more coefficients within the block according to the scanning order associated with the block is the same as the position of the respective coefficient within the block according to all other scanning orders that may have been used to code the block.

In one such example, the scanning order associated with the block may comprise one of a zig-zag scanning order and a horizontal scanning order originating at a common position within the block. According to this example, if the position of the last significant coefficient within the block according to the scanning order does not correspond to the common position, or to a next position within the block following the common position according to the zig-zag and the horizontal scanning orders, an indication of whether the scanning order is the zig-zag scanning order or the horizontal scanning order may be coded. In the event the position of the last significant coefficient within the block according to the scanning order corresponds to the common position or the next position, no scanning order information for the block may be coded, i.e., the scanning order information may not be necessary to decode the block.

In other examples, the other scanning order may include only some of the scanning orders other than the scanning order associated with the block that may have been used to code the block. In these examples, the coding efficiency may be improved by coding the scanning order information for the block in an incremental manner, to the extent necessary to decode the block.

In one such example, the scanning order associated with the block may comprise one of a zig-zag scanning order, a horizontal scanning order, and a vertical scanning order originating at a common position within the block. According to this example, in the event a position of a last significant coefficient within the block according to the scanning order corresponds to the common position, no scanning order information for the block may be coded, i.e., the scanning order information may not be necessary to decode the block, as previously described. In the event the position of the last significant coefficient within the block according to the scanning order does not correspond to the common position, a first signal may be coded to indicate whether the scanning order is the vertical scanning order.

In the event the scanning order is the vertical scanning order, no additional scanning order information for the block may be coded, i.e., the first signal indicates the scanning order information for the block. In the event the scanning order is not the vertical scanning order, a further determination may be made whether the position of the last significant coefficient within the block according to the scanning order corresponds to a next position within the block following the common position according to the zig-zag and the horizontal scanning orders.

In the event the position of the last significant coefficient within the block according to the scanning order corresponds to the next position, no further scanning order information may be coded for the block, i.e., no further scanning order information may be necessary to decode the block. In the event the position of the last significant coefficient within the block according to the scanning order does not correspond to the next position, a second signal may be coded to indicate whether the scanning order is the zig-zag scanning order, or the horizontal scanning order.

In this manner, the coding efficiency may be improved by avoiding coding the scanning order information for the block if the position of each of the one or more coefficients within the block according to the scanning order associated with the block is the same as the position of the respective coefficient within the block according to all other scanning orders that may have been used to code the block. Additionally, in cases where the position of each of the one or more coefficients within the block according to the scanning order associated with the block is the same as the position of the respective coefficient within the block according to only some of the other scanning orders that may have been used to code the block, the coding efficiency may be improved by coding the scanning order information for the block in an incremental manner, to the extent necessary to decode the block.

Accordingly, the techniques of this disclosure may improve data compression insofar as scanning order information for one or more blocks of video data used to code the blocks may not be coded, or, if coded, may be more compressed than similar information coded using other methods. In this manner, there may be a relative bit savings for a coded bitstream including the scanning order information for the one or more blocks when using the techniques of this disclosure.

The techniques of this disclosure may, in some examples, be used with any context adaptive entropy coding methodology, including context adaptive entropy coding (CABAC), probability interval partitioning entropy coding (PIPE), or another context adaptive entropy coding methodology. CABAC is described in this disclosure for purposes of illustration, but without limitation as to the techniques broadly described in this disclosure. Also, the techniques may be applied to coding of other types of data generally, e.g., in addition to video data.

In one example, a method of coding coefficients associated with a block of video data during a video coding process includes coding information that identifies a first scanning order associated with the block if a position of any of one or more of the coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order. The method further includes avoiding coding the information that identifies the first scanning order if the position of each of the one or more of the coefficients within the block according to the first scanning order is the same as the position of the respective coefficient within the block according to the second scanning order.

In another example, an apparatus for coding coefficients associated with a block of video data during a video coding process includes a video coder configured to code information that identifies a first scanning order associated with the block if a position of any of one or more of the coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order. The video coder is further configured to avoid coding the information that identifies the first scanning order if the position of each of the one or more of the coefficients within the block according to the first scanning order is the same as the position of the respective coefficient within the block according to the second scanning order.

In another example, a device for coding coefficients associated with a block of video data during a video coding process includes means for coding information that identifies a first scanning order associated with the block if a position of any of one or more of the coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order. The device further includes means for avoiding coding the information that identifies the first scanning order if the position of each of the one or more of the coefficients within the block according to the first scanning order is the same as the position of the respective coefficient within the block according to the second scanning order.

The techniques described in this disclosure may be implemented in hardware, software, firmware, or combinations thereof. If implemented in hardware, an apparatus may be realized as an integrated circuit, a processor, discrete logic, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a tangible computer-readable medium and loaded and executed in the processor.

Accordingly, this disclosure also contemplates a computer-readable medium comprising instructions that, when executed, cause a processor to code coefficients associated with a block of video data during a video coding process, wherein the instructions cause the processor to code information that identifies a first scanning order associated with the block if a position of any of one or more of the coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order. The computer-readable medium further comprises instructions that, when executed, cause the processor to avoid coding the information that identifies the first scanning order if the position of each of the one or more of the coefficients within the block according to the first scanning order is the same as the position of the respective coefficient within the block according to the second scanning order.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram that illustrates an example of a video encoding and decoding system that may implement techniques for efficiently coding scanning order information for a block of video data, consistent with the techniques of this disclosure.

FIG. 2 is a block diagram that illustrates an example of a video encoder that may implement techniques for efficiently encoding scanning order information for a block of video data, consistent with the techniques of this disclosure.

FIG. 3 is a block diagram that illustrates an example of a video decoder that may implement techniques for efficiently decoding encoded scanning order information for a block of video data, consistent with the techniques of this disclosure.

FIGS. 4A-4C are conceptual diagrams that illustrate an example of a block of video data and corresponding significant coefficient position information and last significant coefficient position information.

FIGS. 5A-5C are conceptual diagrams that illustrate examples of blocks of video data scanned using a zig-zag scanning order, a horizontal scanning order, and a vertical scanning order.

FIGS. 6A-6C are conceptual diagrams that illustrate additional examples of blocks of video data scanned using a zig-zag scanning order, a horizontal scanning order, and a vertical scanning order.

FIG. 7 is a flowchart that illustrates an example of a method for efficiently coding scanning order information for a block of video data, consistent with the techniques of this disclosure.

FIG. 8 is a flowchart that illustrates an example of a method for efficiently encoding scanning order information for a block of video data, consistent with the techniques of this disclosure.

FIG. 9 is a flowchart that illustrates an example of a method for efficiently decoding encoded scanning order information for a block of video data, consistent with the techniques of this disclosure.

FIG. 10 is a flowchart that illustrates another example of a method for efficiently encoding scanning order information for a block of video data, consistent with the techniques of this disclosure.

FIG. 11 is a flowchart that illustrates another example of a method for efficiently decoding encoded scanning order information for a block of video data, consistent with the techniques of this disclosure.

### DETAILED DESCRIPTION

This disclosure describes techniques for coding coefficients associated with a block of video data during a video coding process, including techniques for coding information that identifies a scanning order associated with the block, i.e., scanning order information for the block. The techniques code information that identifies a first scanning order associated with the block if a position of any of one or more of the coefficients within the block, starting with a first coefficient within the block according to the first scanning order and ending with a last non-zero, or “significant” coefficient within the block according to the first scanning order, and proceeding according to the first scanning order, according to the first scanning order is different than a position of the respective coefficient within the block according to a second scanning order, wherein the second scanning order is different than the first scanning order. The techniques avoid coding the information that identifies the first scanning order if the position of each of the one or more of the coefficients within the block according to the first scanning order is the same as the position of the respective coefficient within the block according to the second scanning order. The techniques of this disclosure may improve efficiency for coding of scanning order information for blocks of video data used to code the blocks. In other words, the techniques may improve compression of the scanning order information for the blocks when the scanning order information is coded.

In this disclosure, the term “coding” refers to encoding that occurs at the encoder or decoding that occurs at the decoder. Similarly, the term coder refers to an encoder, a decoder, or a combined encoder/decoder (CODEC). The terms coder, encoder, decoder and CODEC all refer to specific machines designed for the coding (encoding and/or decoding) of video data consistent with this disclosure.

The techniques of this disclosure may exploit similarity between scanning orders used to code blocks of video data. In some examples, when coding significant coefficient flags and last significant coefficient flags for a block of video data, e.g., a block of quantized transform coefficients, as described in greater detail below, a position of each of one or more coefficients within the block, starting with a first coefficient within the block according to a scanning order associated with the block and ending with a last significant coefficient within the block according to the scanning order, and proceeding according to the scanning order, according to the first scanning order may be the same as a position of the respective coefficient within the block according to another scanning order. In particular, each of the one or more coefficients may be located in a position within the block that is the same according to some or all scanning orders that may have been used to code the block, e.g., some or all scanning orders that may be used in the corresponding coding system to code blocks of video data. In these examples, exact knowledge of information that identifies the scanning order associated with the block, i.e., the scanning order information for the block, may not be necessary to decode the block, and, therefore, the scanning order information may not be coded, or may be coded only to the extent necessary to decode the block. By eliminating the scanning order information in cases where the scanning order does not affect the coding process, or coding the scanning order information only to the extent necessary to perform the coding process, coding efficiency may be improved, and additional compression may be achieved.

In some examples, the other scanning order may include all scanning orders other than the scanning order associated with the block that may have been used to code the block, e.g., all scanning orders other than the scanning order associated with the block that are also used within the corresponding coding system to code blocks of video data. In other words, the coding efficiency may be improved by avoiding coding the scanning order information for the block if the position of each of the one or more of the coefficients within the block according to the scanning order associated with the block is the same as the position of the respective coefficient within the block according to all other scanning orders that may have been used to code the block.

In one such example, the scanning order associated with the block may comprise one of a zig-zag scanning order and a horizontal scanning order originating at a common position within the block. According to this example, in the event the position of the last significant coefficient within the block according to the scanning order does not correspond to the common position, or to a next position within the block following the common position according to the zig-zag and the horizontal scanning orders, an indication of whether the scanning order is the zig-zag scanning order or the horizontal scanning order may be coded. In the event the position of the last significant coefficient within the block according to the scanning order corresponds to the common position or the next position, no scanning order information for the block may be coded, i.e., the scanning order information may not be necessary to decode the block.

In other examples, the other scanning order may include only some of the scanning orders other than the scanning order associated with the block that may have been used to code the block. In these examples, the coding efficiency may be improved by coding the scanning order information for the block in an incremental manner, to the extent necessary to decode the block.

In one such example, the scanning order associated with the block may comprise one of a zig-zag scanning order, a horizontal scanning order, and a vertical scanning order originating at a common position within the block. According to this example, in the event a position of a last significant coefficient within the block according to the scanning order corresponds to the common position, no scanning order information for the block may be coded, i.e., the scanning order information may not be necessary to decode the block, as previously described. In the event the position of the last significant coefficient within the block according to the scanning order does not correspond to the common position, a first signal may be coded to indicate whether the scanning order is the vertical scanning order.

In the event the scanning order is the vertical scanning order, no additional scanning order information for the block may be coded, i.e., the first signal indicates the scanning order information for the block. In the event the scanning order is not the vertical scanning order, a further determination may be made whether the position of the last significant coefficient within the block according to the scanning order corresponds to a next position within the block following the common position according to the zig-zag and the horizontal scanning orders.

In the event the position of the last significant coefficient within the block according to the scanning order corresponds to the next position, no further scanning order information may be coded for the block, i.e., no further scanning order information may be necessary to decode the block. In the event the position of the last significant coefficient within the block according to the scanning order does not correspond to the next position, a second signal may be coded to indicate whether the scanning order is the zig-zag scanning order, or the horizontal scanning order.

As illustrated by the examples described above, this disclosure concerns the timing of signaling the scanning order information for a block of video data (e.g., after it is determined that the scanning order information is necessary to decode the block). The techniques can eliminate signaling of the scanning order information for the block in cases where significant coefficients, e.g., non-zero quantized transform coefficients, of the block are not included in positions within the block that have different designations according to the various scanning orders that may be used to code the block. In these cases, the scanning order information for the block is not necessary to decode the block, and is therefore not coded, which can improve compression of the video data.

The techniques can also reduce signaling of the scanning order information for the block in cases where significant coefficients of the block are included in positions within the block that have different designations according to only some of the various scanning orders that may be used to code the block. In these cases, the exact scanning order information for the block may not be necessary to decode the block, and is therefore coded in an incremental manner, to the extent necessary to decode the block, which once again can improve compression of the video data.

Coding scanning order information for one or more blocks of video data in the manner described above may enable coding the scanning order information more efficiently than when coding the information in all cases, or when using other methods to code the information. Accordingly, the techniques of this disclosure may improve data compression insofar as the resulting scanning order information may not be coded, or, if coded, may be more compressed than similar information coded using other methods. In this manner, there may be a relative bit savings for a coded bitstream including the scanning order information for the one or more blocks when using the techniques of this disclosure.

The techniques of this disclosure may, in some examples, be used with any context adaptive entropy coding methodology, including context adaptive entropy coding (CABAC), probability interval partitioning entropy coding (PIPE), or another context adaptive entropy coding methodology. CABAC is described in this disclosure for purposes of illustration, but without limitation as to the techniques broadly described in this disclosure. Also, the techniques may be applied to coding of other types of data generally, e.g., in addition to video data.

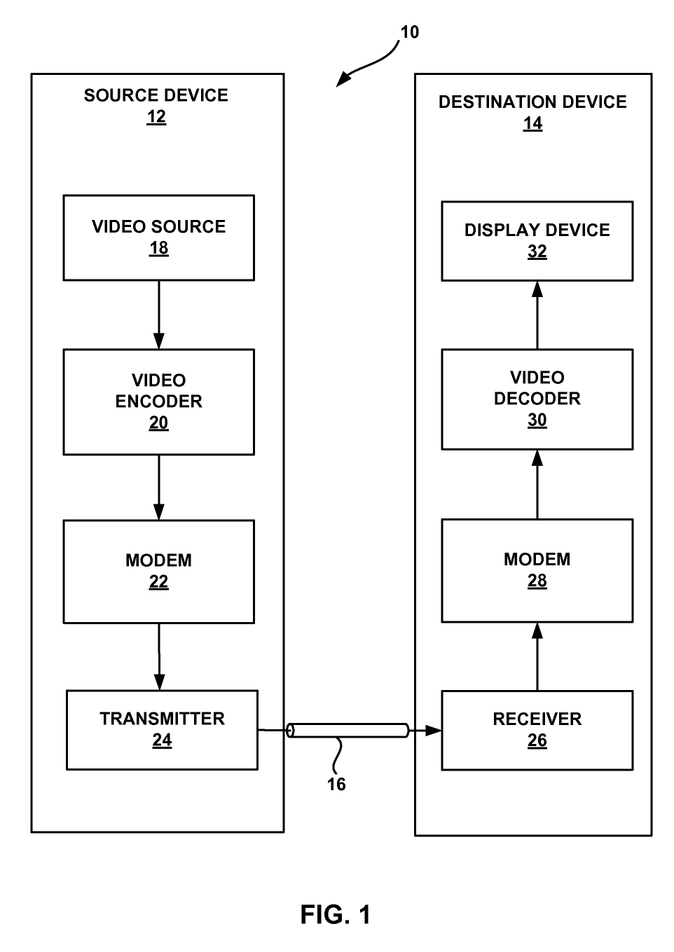

FIG. 1 is a block diagram that illustrates an example of a video encoding and decoding system 10 that may implement techniques for efficiently coding scanning order information for a block of video data, consistent with the techniques of this disclosure. As shown in FIG. 1, system 10 includes a source device 12 that transmits encoded video to a destination device 14 via a communication channel 16. Source device 12 and destination device 14 may comprise any of a wide range of devices. In some cases, source device 12 and destination device 14 may comprise wireless communication devices, such as wireless handsets, so-called cellular or satellite radiotelephones, or any wireless devices that can communicate video information over a communication channel 16, in which case communication channel 16 is wireless.

The techniques of this disclosure, however, which concern efficiently coding scanning order information for a block of video data, are not necessarily limited to wireless applications or settings. These techniques may generally apply to any scenario where encoding or decoding is performed, including over-the-air television broadcasts, cable television transmissions, satellite television transmissions, streaming Internet video transmissions, encoded digital video that is encoded onto a storage medium or retrieved and decoded from a storage medium, or other scenarios. Accordingly, communication channel 16 is not required and the techniques of this disclosure may apply to settings where encoding is applied or where decoding is applied, e.g., without any data communication between encoding and decoding devices.

In the example of FIG. 1, source device 12 includes a video source 18, video encoder 20, a modulator/demodulator (modem) 22 and a transmitter 24. Destination device 14 includes a receiver 26, a modem 28, a video decoder 30, and a display device 32. In accordance with this disclosure, video encoder 20 of source device 12 and/or video decoder 30 of destination device 14 may be configured to apply the techniques for efficiently coding scanning order information for a block of video data. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for efficiently coding scanning order information for a block of video data may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 includes video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be modulated by modem 22 according to a communication standard, and transmitted to destination device 14 via transmitter 24. Modem 22 may include various mixers, filters, amplifiers or other components designed for signal modulation. Transmitter 24 may include circuits designed for transmitting data, including amplifiers, filters, and one or more antennas.

Receiver 26 of destination device 14 receives information over channel 16, and modem 28 demodulates the information. Again, the video encoding process described above may implement one or more of the techniques described herein to efficiently code scanning order information for a block of video data. The information communicated over channel 16 may include syntax information defined by video encoder 20, which is also used by video decoder 30, that includes syntax elements that describe characteristics and/or processing of blocks of video data (e.g., macroblocks, or coding units), e.g., scanning order information for the blocks, and other information. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

In the example of FIG. 1, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14. In other examples, encoding or decoding devices may implement techniques of this disclosure without any communication between such devices. For example, an encoding device may encode and store an encoded bitstream consistent with the techniques of this disclosure. Alternatively, a decoding device may receive or retrieve an encoded bitstream, and decode the bitstream consistent with the techniques of this disclosure.

Video encoder 20 and video decoder 30 may operate according to a video compression standard, such as the ITU-T H.264 standard, alternatively referred to as MPEG-4, Part 10, Advanced Video Coding (AVC). The techniques of this disclosure, however, are not limited to any particular coding standard. Other examples include MPEG-2, ITU-T H.263, and the High Efficiency Video Coding (HEVC) standard presently under development. In general, the techniques of this disclosure are described with respect to HEVC, but it should be understood that these techniques may be used in conjunction with other video coding standards as well. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder and decoder circuitry, such as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 30 may be included in one or more encoders or decoders, either of which may be integrated as part of a combined encoder/decoder (CODEC) in a respective camera, computer, mobile device, subscriber device, broadcast device, set-top box, server, or the like.

A video sequence typically includes a series of video frames. A group of pictures (GOP) generally comprises a series of one or more video frames. A GOP may include syntax data in a header of the GOP, a header of one or more frames of the GOP, or elsewhere, that describes a number of frames included in the GOP. Each frame may include frame syntax data that describes an encoding mode for the respective frame. A video encoder, e.g., video encoder 20, typically operates on video blocks within individual video frames in order to encode the video data. According to the ITU-T H.264 standard, a video block may correspond to a macroblock or a partition of a macroblock. According to other standards, e.g., HEVC described in greater detail below, a video block may correspond to a coding unit (e.g., a largest coding unit), or a partition of a coding unit. The video blocks may have fixed or varying sizes, and may differ in size according to a specified coding standard. Each video frame may include a plurality of slices, i.e., portions of the video frame. Each slice may include a plurality of video blocks, which may be arranged into partitions, also referred to as sub-blocks.

Depending on the specified coding standard, video blocks may be partitioned into various “N×N” sub-block sizes, such as 16×16, 8×8, 4×4, 2×2, and so forth. In this disclosure, “N×N” and “N by N” may be used interchangeably to refer to the pixel dimensions of the block in terms of vertical and horizontal dimensions, e.g., 16×16 pixels or 16 by 16 pixels. In general, a 16×16 block will have sixteen pixels in a vertical direction (y=16) and sixteen pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N. As one example, in the ITU-T H.264 standard, blocks that are 16 by 16 pixels in size may be referred to as macroblocks, and blocks that are less than 16 by 16 pixels may be referred to as partitions of a 16 by 16 macroblock. In other standards, e.g., HEVC, blocks may be defined more generally with respect to their size, for example, as coding units and partitions thereof, each having a varying, rather than a fixed size.

Video blocks may comprise blocks of pixel data in the pixel domain, or blocks of transform coefficients in the transform domain, e.g., following application of a transform, such as a discrete cosine transform (DCT), an integer transform, a wavelet transform, or a conceptually similar transform to residual data for a given video block, wherein the residual data represents pixel differences between video data for the block and predictive data generated for the block. In some cases, video blocks may comprise blocks of quantized transform coefficients in the transform domain, wherein, following application of a transform to residual data for a given video block, the resulting transform coefficients are also quantized.

Block partitioning serves an important purpose in block-based video coding techniques. Using smaller blocks to code video data may result in better prediction of the data for locations of a video frame that include high levels of detail, and may therefore reduce the resulting error (i.e., deviation of the prediction data from source video data), represented as residual data. While potentially reducing the residual data, such techniques may, however, require additional syntax information to indicate how the smaller blocks are partitioned relative to a video frame, and may result in an increased coded video bitrate. Accordingly, in some techniques, block partitioning may depend on balancing the desirable reduction in residual data against the resulting increase in bitrate of the coded video data due to the additional syntax information.

In general, blocks and the various partitions thereof (i.e., sub-blocks) may be considered video blocks. In addition, a slice may be considered to be a plurality of video blocks (e.g., macroblocks, or coding units), and/or sub-blocks (partitions of marcoblocks, or sub-coding units). Each slice may be an independently decodable unit of a video frame. Alternatively, frames themselves may be decodable units, or other portions of a frame may be defined as decodable units. Furthermore, a GOP, also referred to as a sequence, may be defined as a decodable unit.

Efforts are currently in progress to develop a new video coding standard, currently referred to as High Efficiency Video Coding (HEVC). The emerging HEVC standard may also be referred to as H.265. The standardization efforts are based on a model of a video coding device referred to as the HEVC Test Model (HM). The HM presumes several capabilities of video coding devices over devices according to, e.g., ITU-T H.264/AVC. For example, whereas H.264 provides nine intra-prediction encoding modes, HM provides as many as thirty-five intra-prediction encoding modes, e.g., based on the size of a block being intra-prediction coded.

HM refers to a block of video data as a coding unit (CU). A CU may refer to a rectangular image region that serves as a basic unit to which various coding tools are applied for compression. In H.264, it may also be called a macroblock. Syntax data within a bitstream may define a largest coding unit (LCU), which is a largest CU in terms of the number of pixels. In general, a CU has a similar purpose to a macroblock of H.264, except that a CU does not have a size distinction. Thus, a CU may be partitioned, or “split” into sub-CUs.

An LCU may be associated with a quadtree data structure that indicates how the LCU is partitioned. In general, a quadtree data structure includes one node per CU of an LCU, where a root node corresponds to the LCU, and other nodes correspond to sub-CUs of the LCU. If a given CU is split into four sub-CUs, the node in the quadtree corresponding to the split CU includes four child nodes, each of which corresponds to one of the sub-CUs. Each node of the quadtree data structure may provide syntax information for the corresponding CU. For example, a node in the quadtree may include a split flag for the CU, indicating whether the CU corresponding to the node is split into four sub-CUs. Syntax information for a given CU may be defined recursively, and may depend on whether the CU is split into sub-CUs.

A CU that is not split (i.e., a CU corresponding a terminal, or “leaf” node in a given quadtree) may include one or more prediction units (PUs). In general, a PU represents all or a portion of the corresponding CU, and includes data for retrieving a reference sample for the PU for purposes of performing prediction for the CU. For example, when the CU is intra-mode encoded, the PU may include data describing an intra-prediction mode for the PU. As another example, when the CU is inter-mode encoded, the PU may include data defining a motion vector for the PU. The data defining the motion vector may describe, for example, a horizontal component of the motion vector, a vertical component of the motion vector, a resolution for the motion vector (e.g., one-quarter pixel precision or one-eighth pixel precision), a reference frame to which the motion vector points, and/or a reference list (e.g., list 0 or list 1) for the motion vector. Data for the CU defining the one or more PUs of the CU may also describe, for example, partitioning of the CU into the one or more PUs. Partitioning modes may differ between whether the CU is uncoded, intra-prediction mode encoded, or inter-prediction mode encoded.

A CU having one or more PUs may also include one or more transform units (TUs). Following prediction for a CU using one or more PUs, as described above, a video encoder may calculate one or more residual blocks for the respective portions of the CU corresponding to the one of more PUs. The residual blocks may represent a pixel difference between the video data for the CU and the predicted data for the one or more PUs. A set of residual values may be transformed, scanned, and quantized to define a set of quantized transform coefficients. A TU may define a partition data structure that indicates partition information for the transform coefficients that is substantially similar to the quadtree data structure described above with reference to a CU. A TU is not necessarily limited to the size of a PU. Thus, TUs may be larger or smaller than corresponding PUs for the same CU. In some examples, the maximum size of a TU may correspond to the size of the corresponding CU. In one example, residual samples corresponding to a CU may be subdivided into smaller units using a quadtree structure known as “residual quad tree” (RQT). In this case, the leaf nodes of the RQT may be referred as the TUs, for which the corresponding residual samples may be transformed and quantized.

Following intra-predictive or inter-predictive encoding to produce predictive data and residual data, and following any transforms (such as the 4×4 or 8×8 integer transform used in H.264/AVC or a discrete cosine transform DCT) to produce transform coefficients, quantization of transform coefficients may be performed. Quantization generally refers to a process in which transform coefficients are quantized to possibly reduce the amount of data used to represent the coefficients. The quantization process may reduce the bit depth associated with some or all of the coefficients. For example, an n-bit value may be rounded down to an m-bit value during quantization, where n is greater than m.

Following quantization, entropy coding of the quantized data (i.e., quantized transform coefficients) may be performed. The entropy coding may conform to the techniques of this disclosure with respect to efficiently coding scanning order information for a block of video data, and may also use other entropy coding techniques, such as context adaptive variable length coding (CAVLC), CABAC, PIPE, or another entropy coding methodology. For example, coefficient values, represented as magnitudes and corresponding signs (e.g., “+1,” or “−1”) for the quantized transform coefficients may be encoded using the entropy coding techniques.

It should be noted that the prediction, transform, and quantization described above may be performed for any block of video data, e.g., to a PU and/or TU of a CU, or to a macroblock, depending on the specified coding standard. Accordingly, the techniques of this disclosure, relating to efficiently coding scanning order information for a block of video data, may apply to any block of video data, e.g., to any block of quantized transform coefficients, including a macroblock, or a TU of a CU. Furthermore, a block of video data (e.g., a macroblock, or a TU of a CU) may include each of a luminance component (Y), a first chrominance component (U), and a second chrominance component (V) of the corresponding video data. As such, the techniques of this disclosure may be performed for each of the Y, U, and V components of a given block of video data.

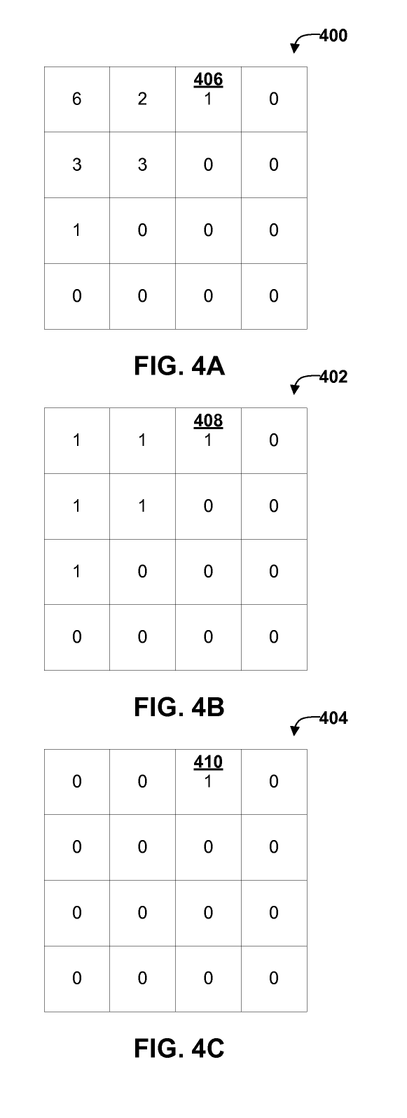

In order to encode blocks of video data as described above, information regarding position of significant coefficients within a given block may also be generated and encoded. Subsequently, the values of the significant coefficients may be encoded, as described above. In H.264/AVC and the emerging HEVC standard, when using a context adaptive entropy coding process, e.g., a CABAC process, the position of significant coefficients within a block of video data may be encoded prior to encoding the values of the significant coefficients. The process of encoding the position of all of the significant coefficients within the block may be referred to as significance map (SM) encoding. FIGS. 4A-4C, described in greater detail below, are conceptual diagrams that illustrate an example of a 4×4 block of quantized transform coefficients and corresponding SM data.

A typical SM encoding procedure may be described as follows. For a given block of video data, an SM may be encoded only if there is at least one significant coefficient within the block. Presence of significant coefficients within a given block of video data may be indicated in a coded block pattern (e.g., using syntax element “coded_block_pattern,” or CBP), which is a binary value coded for a set of blocks (such as luminance and chrominance blocks) associated with an area of pixels in the video data. Each bit in the CBP is referred to as a coded block flag (e.g., corresponding to syntax element “coded_block_flag”) and used to indicate whether there is at least one significant coefficient within its corresponding block. In other words, a coded block flag is a one-bit symbol indicating whether there are any significant coefficients inside a single block of transform coefficients, and a CBP is a set of coded block flags for a set of related video data blocks.

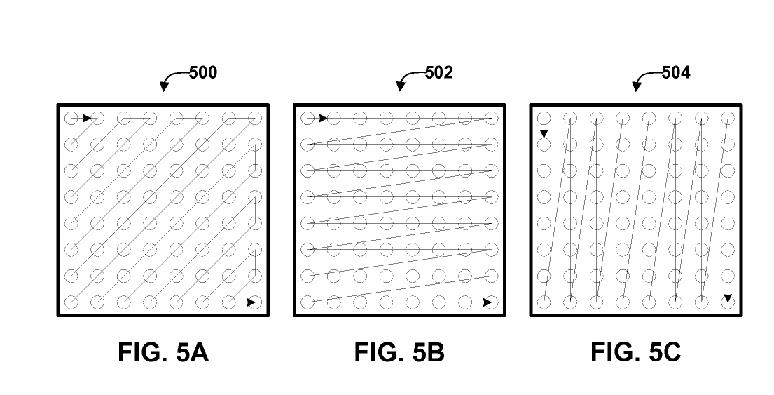

If a coded block flag indicates that no significant coefficients are present within the corresponding block (e.g., the flag equals “0”), no further information may be encoded for the block. However, if a coded block flag indicates that at least one significant coefficient exists within the corresponding block (e.g., the flag equals “1”), an SM may be encoded for the block by following a coefficient scanning order associated with the block. The scanning order may define the order in which the significance of each coefficient within the block is encoded as part of the SM encoding. In other words, scanning may serialize the two-dimensional block of coefficients to a one-dimensional representation to determine the significance of the coefficients. Different scanning orders (e.g., zigzag, horizontal, and vertical) may be used. FIGS. 5A-5C, also described in greater detail below, illustrate examples of some of the various scanning orders that may be used for 8×8 blocks of video data. The techniques of this disclose, however, may also apply with respect to a wide variety of other scanning orders, including a diagonal scanning order, scanning orders that are combinations of zigzag, horizontal, vertical, and/or diagonal scanning orders, as well as scanning orders that are partially zigzag, partially horizontal, partially vertical, and/or partially diagonal. In addition, the techniques of this disclosure may also consider a scanning order that is itself adaptive based on statistics associated with previously coded blocks of video data (e.g., blocks having the same block size or coding mode as the current block being coded). For example, an adaptive scanning order could be the scanning order associated with the block, in some cases.

Given a coded block flag that indicates that at least one significant coefficient exists within a given block, and a scanning order for the block, an SM for the block may be encoded as follows. The two-dimensional block of quantized transform coefficients may first be mapped into a one-dimensional array using the scanning order. For each coefficient in the array, following the scanning order, a one-bit significant coefficient flag (e.g., corresponding to syntax element “significant_coeff_flag”) may be encoded. That is, each position in the array may be assigned a binary value, which may be set to “1” if the corresponding coefficient is significant, and set to “0” if it is non-significant (i.e., zero).

If a given significant coefficient flag equals “1,” indicating that the corresponding coefficient is significant, an additional one-bit last significant coefficient flag (e.g., corresponding to syntax element “last_significant_coeff_flag”) may also be encoded, which may indicate whether the corresponding coefficient is the last significant coefficient within the array (i.e., within the block given the scanning order). Specifically, each last significant coefficient flag may be set to “1” if the corresponding coefficient is the last significant coefficient within the array, and set to “0” otherwise. If the last array position is reached in this manner, and the SM encoding process was not terminated by a last significant coefficient flag equal to “1,” then the last coefficient in the array (and thereby the block given the scanning order) may be inferred to be significant, and no last significant coefficient flag may be encoded for the last array position.

FIGS. 4B-4C are conceptual diagrams that illustrate examples of sets of significant coefficient flags and last significant coefficient flags, respectively, corresponding to SM data for the block depicted in FIG. 4A, presented in map, rather than array form. It should be noted that significant coefficient flags and last significant coefficient flags, as described above, may be set to different values (e.g., a significant coefficient flag may be set to “0” if the corresponding coefficient is significant, and “1” if it is non-significant, and a last significant coefficient flag may be set to “0” if the corresponding coefficient is the last significant coefficient, and “1” if it is not the last significant coefficient) in other examples.

After the SM is encoded, as described above, the value of each significant coefficient (i.e., each significant coefficient's magnitude and sign, e.g., indicated by syntax elements “coeff_abs_level_minus1” and “coeff_sign_flag,” respectively) in the block may also be encoded.

According to some techniques, a fixed scanning order may be used to code blocks of video data, as described above, e.g., the zig-zag scanning order. According to other techniques, multiple scanning orders may be used to code the blocks. In some examples, “adaptive coefficient scanning” (ACS) may be used, wherein the scanning order adapts over time, and the currently adapted scanning order is used to code a particular block of coefficients at any given time. In still other techniques, video encoder 20 may test several scanning orders based on one or more compression efficiency metrics and select the best scanning order to encode the blocks. Additionally, video encoder 20 may indicate the scanning order to video decoder 30 by encoding an ACS index, which may represent any one of the several scanning orders (e.g., using indices 0 for zig-zag, 1 for horizontal, and 2 for vertical scanning orders).

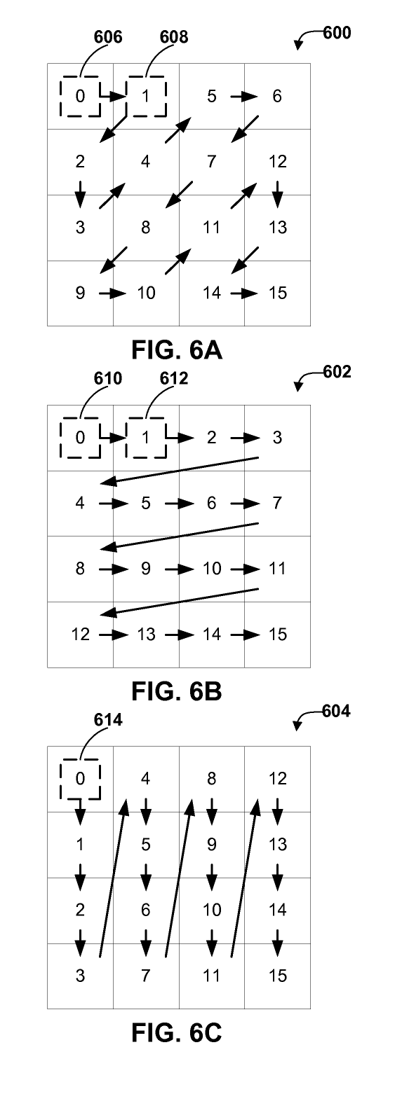

According to some techniques, video encoder 20 may encode the ACS index only when the last significant coefficient is not located in the first position in the scanning order (corresponding to the top-left position within the block commonly referred to as the “DC” position). Video encoder 20 may encode the ACS index in this manner because video decoder 30 does not need an indication of the scanning order used by video encoder 20 in the case the last (and only) significant coefficient within the block is located in the DC position, since all possible scanning orders may start with the DC position, as shown in FIGS. 5 and 6, also described in greater detail below.

In the event the last significant coefficient within the block is not located in the DC position, video encoder 20 may encode the ACS index in the following manner. Video encoder 20 may encode a first signal (e.g., “bin1”) that indicates whether the scanning order is the zig-zag scanning order (e.g., bin1=“0”) or not (e.g., bin1=“1”). In the event the scanning order is not the zig-zag scanning order, video encoder 20 may encode a second signal (e.g., “bin2”) that indicates whether the scanning order is the horizontal scanning order (e.g., bin2=“0”) or the vertical scanning order (e.g., bin2=“1”). Similarly, video decoder 30 may receive and decode the first signal and the second signal to determine the ACS index. Accordingly, rather than always coding the ACS index, video encoder 20 and/or video decoder 30 may code the ACS index only when the last significant coefficient is not located in the DC position.

One drawback of the techniques described above is that video encoder 20 and/or video decoder 30 coding the ACS index for the block, i.e., the scanning order information for the block, only when the last significant coefficient is not located in the DC position may place redundant information in the resulting coded bitstream. As previously described, in some examples, all scanning orders used within system 10 comprising video encoder 20 and video decoder 30 may start at the DC position and diverge at subsequent block positions, depending on the scanning orders. Video encoder 20 and/or video decoder 30 coding the ACS index only when the last significant coefficient is not located in the DC position ignores the fact that some of the scanning orders are identical for block positions beyond the DC position (e.g., the first two positions within the zig-zag and the horizontal scanning orders, as shown in FIGS. 5 and 6). In these cases, video encoder 20 does not need to indicate to video decoder 30 which scanning order was used by video encoder 20 to encode the block in the event the last significant coefficient is located before the point where the scanning orders diverge and become distinguishable.

Accordingly, this disclosure describes techniques that may enable coding scanning order information for a block of video data more efficiently than when using other techniques to code similar information. For example, the scanning order information may be coded more efficiently by avoiding coding the scanning order information for the block if a position of each of one or more coefficients within the block, starting with a first coefficient within the block according to the scanning order used to code the block and ending with a last significant coefficient within the block according to the scanning order, and proceeding according to the scanning order, according to the scanning order is the same as a position of the respective coefficient within the block according to all other scanning orders that may have been used to code the block. Additionally, in cases where the position of each of the one or more coefficients within the block according to the scanning order used to code the block is the same as a position of the respective coefficient within the block according to only some of the other scanning orders that may have been used to code the block, the scanning order information may be coded more efficiently by coding the scanning order information for the block in an incremental manner, to the extent necessary to decode the block.

In some examples, video encoder 20 of source device 12 may be configured to encode certain blocks of video data (e.g., one or more macroblocks, or TUs of a CU), and video decoder 30 of destination device 14 may be configured to receive the encoded video data from video encoder 20, e.g., from modem 28 and receiver 26.

In accordance with the techniques of this disclosure, as one example, video encoder 20 and/or video decoder 30 may be configured to code information that identifies a first scanning order associated with a block of video data, i.e., scanning order information for the block, if a position of any of one or more coefficients within the block, starting with a first coefficient within the block according to the first scanning order and ending with a last significant coefficient within the block according to the first scanning order, and proceeding according to the first scanning order, according to the first scanning order is different than a position of the respective coefficient within the block according to a second scanning order, wherein the second scanning order is different than the first scanning order. Video encoder 20 and/or video decoder 30 may be further configured to avoid coding the scanning order information for the block if the position of each of the one or more coefficients within the block according to the first scanning order is the same as the position of the respective coefficient within the block according to the second scanning order.

In some examples, the first scanning order and the second scanning order may each comprise one of a zig-zag scanning order and a horizontal scanning order originating at a common position within the block. For example, the common position may be the DC position, as previously described. The zig-zag and horizontal scanning orders may “overlap” for the first two positions within either scanning order, as also previously described. To encode the scanning order information for the block if the position of any of the one or more coefficients within the block according to the first scanning order is different than the position of the respective coefficient within the block according to the second scanning order, video encoder 20 may be configured to determine whether the position of the last significant coefficient within the block according to the first scanning order corresponds to the common position, or to a next position within the block following the common position according to the zig-zag and the horizontal scanning orders.

To make this determination, video encoder 20 may be configured to encode significant coefficient flags and last significant coefficient flags for coefficients within the block corresponding to the common position and the next position, using the techniques previously described. Specifically, video encoder 20 may be configured to determine whether the last significant coefficient flag for either coefficient indicates that the coefficient is the last significant coefficient within the block according to the first scanning order.

In the event the position of the last significant coefficient within the block according to the first scanning order does not correspond to the common position or the next position, video encoder 20 may be further configured to encode an indication of whether the first scanning order is the zig-zag scanning order or the horizontal scanning order. For example, the indication may comprise a single bit, or “bin,” the value of which indicates whether the first scanning order is the zig-zag scanning order or the horizontal scanning order.

Furthermore, video decoder 30 may be configured to receive a signal that indicates the scanning order information for the block when the position of the last significant coefficient within the block according to the first scanning order does not correspond to the common position, or to the next position within the block following the common position according to the zig-zag and the horizontal scanning orders. For example, video decoder 30 may be configured to expect to receive the signal based on values of previously decoded significant coefficient flags and last significant coefficient flags for coefficients within the block corresponding to the common position and the next position received from video encoder 20, using the techniques previously described. Specifically, video decoder 30 may be configured to receive the signal when the last significant coefficient flags for both coefficients indicate that neither coefficient is the last significant coefficient within the block according to the first scanning order.

Video decoder 30 may be further configured to decode the signal to determine whether the first scanning order is the zig-zag scanning order or the horizontal scanning order. For example, video decoder 30 may be configured to decode the signal to determine the single bin, and determine whether the first scanning order is the zig-zag scanning order or the horizontal scanning order based on the value of the single bin.

In the event the position of the last significant coefficient within the block according to the first scanning order corresponds to the common position or the next position, video encoder 20 may be configured to not encode any scanning order information for the block, i.e., the scanning order information may not be necessary for video decoder 30 to decode the block. Accordingly, in this case, video decoder 30 may be configured to not receive the signal that indicates the scanning order information for the block.

In a similar manner as described above, in other examples, the first scanning order and the second scanning order may each comprise one of a diagonal scanning order and a vertical scanning order originating at a common position within the block. For example, the diagonal and vertical scanning orders may also overlap for the first two positions within either scanning order, as previously described.

In other examples, the first scanning order and the second scanning order may each comprise one of a zig-zag scanning order, a horizontal scanning order, and a vertical scanning order originating at a common position within the block. Once again, for example, the common position may be the DC position, as previously described. The zig-zag and horizontal scanning orders may overlap for the first two positions within either scanning order, as also previously described.

To encode the scanning order information for the block if the position of any of the one or more coefficients within the block according to the first scanning order is different than the position of the respective coefficient within the block according to the second scanning order, video encoder 20 may be configured to determine whether the position of the last significant coefficient within the block according to the first scanning order corresponds to the common position.

To make this determination, video encoder 20 may be configured to encode a significant coefficient flag and a last significant coefficient flag for a coefficient within the block corresponding to the common position, using the techniques previously described. Specifically, video encoder 20 may be configured to determine whether the last significant coefficient flag for the coefficient indicates that the coefficient is the last significant coefficient within the block according to the first scanning order.

In the event the position of the last significant coefficient within the block according to the first scanning order corresponds to the common position, video encoder 20 may be configured to not encode any scanning order information for the block, i.e., the scanning order information may not be necessary for video decoder 30 to decode the block. Accordingly, in this case, video decoder 30 may be configured to not receive any scanning order information for the block.

In the event the position of the last significant coefficient within the block according to the first scanning order does not correspond to the common position, video encoder 20 may be further configured to encode an indication of whether the first scanning order is the vertical scanning order using a first signal. For example, the first signal may comprise a first bin, the value of which indicates whether the first scanning order is the vertical scanning order.

Furthermore, video decoder 30 may be configured to receive the first signal that indicates the scanning order information for the block when the position of the last significant coefficient within the block according to the first scanning order does not correspond to the common position. For example, video decoder 30 may be configured to expect to receive the first signal based on values of previously decoded significant coefficient flag and last significant coefficient flag for the coefficient within the block corresponding to the common position received from video encoder 20, using the techniques previously described. Specifically, video decoder 30 may be configured to receive the first signal when the last significant coefficient flag for the coefficient indicates that the coefficient is not the last significant coefficient within the block according to the first scanning order.

Video decoder 30 may be further configured to decode the first signal to determine whether the first scanning order is the vertical scanning order. For example, video decoder 30 may be configured to decode the first signal to determine the first bin, and determine whether the first scanning order is the vertical scanning order based on the value of the first bin. In the event the first scanning order is the vertical scanning order, video encoder 20 may be configured to not encode any additional scanning order information for the block, i.e., no additional scanning order information may be necessary for video decoder 30 to decode the block. Accordingly, in this case, video decoder 30 may be configured to not receive any additional scanning order information for the block beyond the first signal.

In the event the first scanning order is not the vertical scanning order, video encoder 20 may be further configured to determine whether the position of the last significant coefficient within the block according to the first scanning order corresponds to a next position within the block following the common position according to the zig-zag and the horizontal scanning orders.

To make this determination, video encoder 20 may be configured to encode a significant coefficient flag and a last significant coefficient flag for a coefficient within the block corresponding to the next position, using the techniques previously described. Specifically, video encoder 20 may be configured to determine whether the last significant coefficient flag for the coefficient indicates that the coefficient is the last significant coefficient within the block according to the first scanning order.

In the event the position of the last significant coefficient within the block according to the first scanning order corresponds to the next position, video encoder 20 may be configured to not encode any additional scanning order information for the block, i.e., no additional scanning order information may be necessary for video decoder 30 to decode the block. Accordingly, in this case, video decoder 30 may be configured to not receive any additional scanning order information for the block beyond the first signal.

In the event the position of the last significant coefficient within the block according to the first scanning order does not correspond to the next position, video encoder 20 may be further configured to encode an indication of whether the first scanning order is the zig-zag scanning order or the horizontal scanning order using a second signal, wherein the second signal is different than the first signal. For example, the second signal may comprise a second bin, the value of which indicates whether the first scanning order is the zig-zag scanning order or the horizontal scanning order.

Video decoder 30 may be further configured to receive the second signal that indicates the scanning order information for the block when the position of the last significant coefficient within the block according to the first scanning order does not correspond to the next position within the block following the common position according to the zig-zag and the horizontal scanning orders. For example, video decoder 30 may be configured to expect to receive the second signal based on values of previously decoded significant coefficient flag and last significant coefficient flag for the coefficient within the block corresponding to the next position received from video encoder 20, using the techniques previously described. Specifically, video decoder 30 may be configured to receive the second signal when the last significant coefficient flag for the coefficient indicates that the coefficient is not the last significant coefficient within the block according to the first scanning order.

Finally, video decoder 30 may be configured to decode the second signal to determine whether the first scanning order is the zig-zag scanning order or the horizontal scanning order. For example, video decoder 30 may be configured to decode the second signal to determine the second bin, and determine whether the first scanning order is the zig-zag scanning order or the horizontal scanning order based on the value of the second bin.

In a similar manner as described above, in other examples, the first scanning order and the second scanning order may each comprise one of a diagonal scanning order, a horizontal scanning order, and a vertical scanning order originating at a common position within the block. For example, the diagonal and vertical scanning orders may also overlap for the first two positions within either scanning order, as previously described.

It should be noted that, in other examples, the techniques described herein may apply to examples where the scanning order information for the block is coded separately from the significant coefficient flags and the last significant coefficient flags, i.e., SM data, for the coefficients within the block. For example, video encoder 20 and/or video decoder 30 may be configured to code the scanning order information for the block after coding the position of the last significant coefficient within the block according to the first scanning order using techniques other than coding last significant coefficient flags, e.g., by explicitly signaling the position of the last significant coefficient within the block.

Additionally, in some examples, to code the scanning order information for the block if the position of any of the one or more coefficients within the block according to the first scanning order is different than the position of the respective coefficient within the block according to the second scanning order, video encoder 20 and/or video decoder 30 may be configured to perform a context adaptive entropy coding process, e.g., a CABAC process. For example, in cases where video encoder 20 is configured to encode the scanning order information for the block using one or more bins, video encoder 20 and/or video decoder 30 may be configured to code each bin by performing the context adaptive entropy coding process using probability estimates for the respective bin.

In these cases, the probability estimates may indicate the likelihood of the respective bin having a given value (e.g., “0” or “1”). In some examples, video encoder 20 and/or video decoder 30 may determine the probability estimates using values of bins for previously coded blocks of video data. In other examples, video encoder 20 and/or video decoder 30 also may update the probability estimates using the value of the respective bin. As a result of video encoder 20 and/or video decoder 30 coding the scanning order information for the block by performing the context adaptive entropy coding process, the information may be more efficiently coded than similar information coded using other techniques.

In any case, as previously described, after the significant coefficient flags and the last significant coefficient flags, i.e., the SM data for the block, and, in some cases, the scanning order information for the block, are coded in the manner described above, the value of each significant coefficient (i.e., each significant coefficient's magnitude and sign, e.g., indicated by syntax elements “coeff_abs_level_minus1” and “coeff_sign_flag,” respectively) within the block may also be coded.

As such, the techniques of this disclosure may enable video encoder 20 and/or video decoder 30 to code the scanning order information for the block more efficiently than when using other methods. In this manner, there may be a relative bit savings for a coded bitstream including the scanning order information when using the techniques of this disclosure.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). An apparatus including video encoder 20 and/or video decoder 30 may comprise an integrated circuit, a microprocessor, and/or a wireless communication device, such as a cellular telephone.

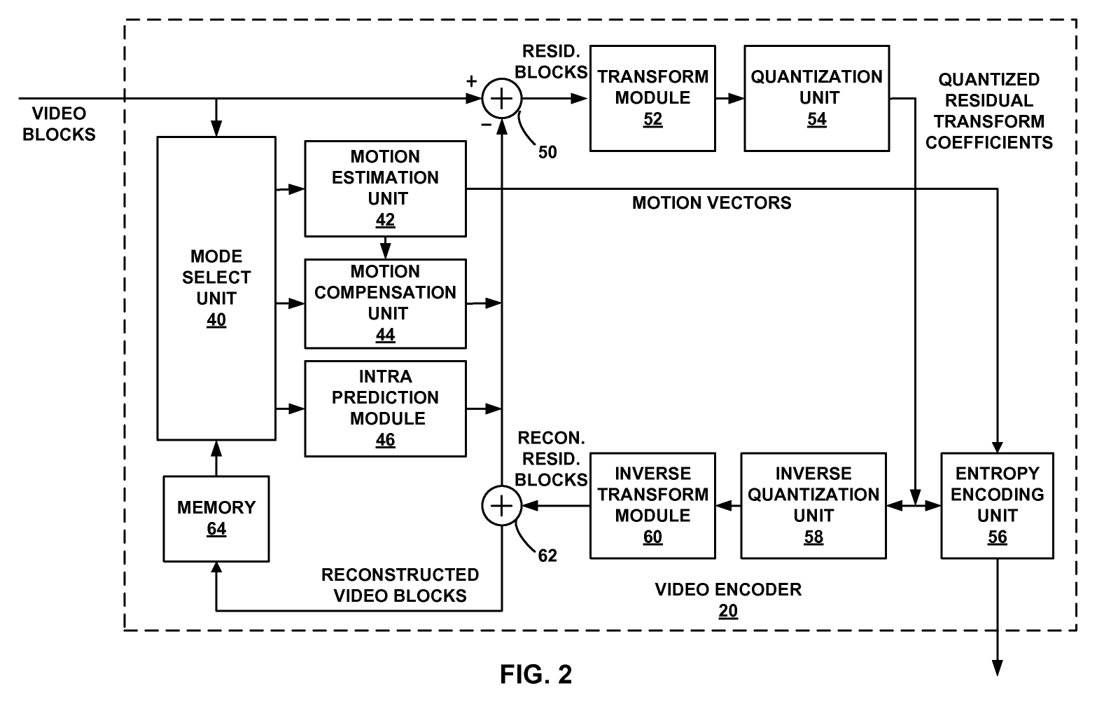

FIG. 2 is a block diagram that illustrates an example of a video encoder 20 that may implement techniques for efficiently encoding scanning order information for a block of video data, consistent with the techniques of this disclosure. Video encoder 20 may perform intra- and inter-coding of blocks within video frames, including macroblocks, CUs, and partitions or sub-partitions thereof. Intra-coding relies on spatial prediction to reduce or remove spatial redundancy in video within a given video frame. Inter-coding relies on temporal prediction to reduce or remove temporal redundancy in video within adjacent frames of a video sequence. Intra-mode (I-mode) may refer to any of several spatial based compression modes, and inter-modes, such as uni-directional prediction (P-mode) or bi-directional prediction (B-mode), may refer to any of several temporal-based compression modes.

As shown in FIG. 2, video encoder 20 receives a current block of video data within a video frame to be encoded. In the example of FIG. 2, video encoder 20 includes motion compensation unit 44, motion estimation unit 42, memory 64, summer 50, transform module 52, quantization unit 54, and entropy encoding unit 56. For video block reconstruction, video encoder 20 also includes inverse quantization unit 58, inverse transform module 60, and summer 62. A deblocking filter (not shown in FIG. 2) may also be included to filter block boundaries to remove blockiness artifacts from reconstructed video. If desired, the deblocking filter would typically filter the output of summer 62.

During the encoding process, video encoder 20 receives a video frame or slice to be coded. The frame or slice may be divided into multiple video blocks. Motion estimation unit 42 and motion compensation unit 44 may perform inter-predictive coding of a given received video block relative to one or more blocks in one or more reference frames to provide temporal compression. Intra-prediction module 46 may perform intra-predictive coding of a given received video block relative to one or more neighboring blocks in the same frame or slice as the block to be coded to provide spatial compression.

Mode select unit 40 may select one of the coding modes, i.e., one mode or multiple intra- or inter-coding modes, based on coding results (e.g., resulting coding rate and level of distortion), and based on a frame or slice type for the frame or slice including the given received block being coded, and provide the resulting intra- or inter-coded block to summer 50 to generate residual block data and to summer 62 to reconstruct the encoded block for use in a reference frame or reference slice. In general, intra-prediction involves predicting a current block relative to neighboring, previously coded blocks, while inter-prediction involves motion estimation and motion compensation to temporally predict the current block.

Motion estimation unit 42 and motion compensation unit 44 represent the inter-prediction elements of video encoder 20. Motion estimation unit 42 and motion compensation unit 44 may be highly integrated, but are illustrated separately for conceptual purposes. Motion estimation is the process of generating motion vectors, which estimate motion for video blocks. A motion vector, for example, may indicate the displacement of a predictive block within a predictive reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. A motion vector may also indicate displacement of a partition of a block. Motion compensation may involve fetching or generating the predictive block based on the motion vector determined by motion estimation. Again, motion estimation unit 42 and motion compensation unit 44 may be functionally integrated, in some examples.

Motion estimation unit 42 may calculate a motion vector for a video block of an inter-coded frame by comparing the video block to video blocks of a reference frame in memory 64. Motion compensation unit 44 may also interpolate sub-integer pixels of the reference frame, e.g., an I-frame or a P-frame, for the purposes of this comparison. The ITU H.264 standard, as an example, describes two lists: list 0, which includes reference frames having a display order earlier than a current frame being encoded, and list 1, which includes reference frames having a display order later than the current frame being encoded. Therefore, data stored in memory 64 may be organized according to these lists.

Motion estimation unit 42 may compare blocks of one or more reference frames from memory 64 to a block to be encoded of a current frame, e.g., a P-frame or a B-frame. When the reference frames in memory 64 include values for sub-integer pixels, a motion vector calculated by motion estimation unit 42 may refer to a sub-integer pixel location of a reference frame. Motion estimation unit 42 and/or motion compensation unit 44 may also be configured to calculate values for sub-integer pixel positions of reference frames stored in memory 64 if no values for sub-integer pixel positions are stored in memory 64. Motion estimation unit 42 may send the calculated motion vector to entropy encoding unit 56 and motion compensation unit 44. The reference frame block identified by a motion vector may be referred to as an inter-predictive block, or, more generally, a predictive block. Motion compensation unit 44 may calculate prediction data based on the predictive block.

Intra-prediction module 46 may intra-predict a current block, as an alternative to the inter-prediction performed by motion estimation unit 42 and motion compensation unit 44, as described above. In particular, intra-prediction module 46 may determine an intra-prediction mode to use to encode a current block. In some examples, intra-prediction module 46 may encode a current block using various intra-prediction modes, e.g., during separate encoding passes, and intra-prediction module 46 (or mode select unit 40, in some examples) may select an appropriate intra-prediction mode to use from the tested modes. For example, intra-prediction module 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction module 46 may calculate ratios from the distortions and rates for the various encoded blocks to determine which intra-prediction mode exhibits the best rate-distortion value for the block.

After predicting a current block, e.g., using intra-prediction or inter-prediction, video encoder 20 may form a residual video block by subtracting the prediction data calculated by motion compensation unit 44 or intra-prediction module 46 from the original video block being coded. Summer 50 represents the component or components that may perform this subtraction operation. Transform module 52 may apply a transform, such as a discrete cosine transform (DCT) or a conceptually similar transform, to the residual block, producing a video block comprising residual transform coefficient values. Transform module 52 may perform other transforms, such as those defined by the H.264 standard, which are conceptually similar to DCT. Wavelet transforms, integer transforms, sub-band transforms or other types of transforms could also be used. In any case, transform module 52 may apply the transform to the residual block, producing a block of residual transform coefficients. The transform may convert the residual information from a pixel domain to a transform domain, such as a frequency domain. Quantization unit 54 may quantize the residual transform coefficients to further reduce bit rate. The quantization process may reduce the bit depth associated with some or all of the coefficients. The degree of quantization may be modified by adjusting a quantization parameter.

Following quantization, entropy encoding unit 56 may entropy encode the quantized transform coefficients, which may include CAVLC, CABAC, PIPE, or another entropy coding technique. Following the entropy coding by entropy encoding unit 56, the encoded video may be transmitted to another device or archived for later transmission or retrieval.

In some cases, entropy encoding unit 56 or another unit of video encoder 20 may be configured to perform other coding functions, in addition to entropy coding quantized transform coefficients as described above. For example, entropy encoding unit 56 may construct header information for the block (e.g., macroblock, CU, or LCU), or video frame containing the block, with appropriate syntax elements for transmission in the encoded video bitstream. According to some coding standards, such syntax elements may include scanning order information for the block, as previously described. As also previously described, the scanning order information may consume a high percentage of the overall compressed video bitrate if coded inefficiently. As such, this disclosure describes techniques that may enable coding the scanning order information for the block more efficiently than when using other methods.

For example, entropy encoding unit 56 of video encoder 20 may be configured to encode certain blocks of video data (e.g., one or more macroblocks, or TUs of a CU). In accordance with the techniques of this disclosure, as one example, entropy encoding unit 56 may be configured to encode information that identifies a first scanning order associated with a block of video data, i.e., scanning order information for the block, if a position of any of one or more coefficients within the block, starting with a first coefficient within the block according to the first scanning order and ending with a last significant coefficient within the block according to the first scanning order, and proceeding according to the first scanning order, according to the first scanning order is different than a position of the respective coefficient within the block according to a second scanning order, wherein the second scanning order is different than the first scanning order. Entropy encoding unit 56 may be further configured to avoid encoding the scanning order information for the block if the position of each of the one or more of the coefficients within the block according to the first scanning order is the same as the position of the respective coefficient within the block according to the second scanning order.

In some examples, once again, the first scanning order and the second scanning order may each comprise one of a zig-zag scanning order and a horizontal scanning order originating at a common position within the block. Once again, for example, the common position may be the DC position, as previously described. The zig-zag and horizontal scanning orders may overlap for the first two positions within either scanning order, as also previously described.

To encode the scanning order information for the block if the position of any of the one or more coefficients within the block according to the first scanning order is different than the position of the respective coefficient within the block according to the second scanning order, entropy encoding unit 56 may be configured to determine whether the position of the last significant coefficient within the block according to the first scanning order corresponds to the common position, or to a next position within the block following the common position according to the zig-zag and the horizontal scanning orders.

Once again, to make this determination, entropy encoding unit 56 may be configured to encode significant coefficient flags and last significant coefficient flags for coefficients within the block corresponding to the common position and the next position, using the techniques previously described. Specifically, entropy encoding unit 56 may be configured to determine whether the last significant coefficient flag for either coefficient indicates that the coefficient is the last significant coefficient within the block according to the first scanning order.

In the event the position of the last significant coefficient within the block according to the first scanning order does not correspond to the common position or the next position, entropy encoding unit 56 may be further configured to encode an indication of whether the first scanning order is the zig-zag scanning order or the horizontal scanning order. For example, the indication may comprise a single bit, or “bin,” the value of which indicates whether the first scanning order is the zig-zag scanning order or the horizontal scanning order.

In the event the position of the last significant coefficient within the block according to the first scanning order corresponds to the common position or the next position, entropy encoding unit 56 may be configured to not encode any scanning order information for the block, i.e., the scanning order information may not be necessary to decode the block.

In a similar manner as described above, in other examples, the first scanning order and the second scanning order may each comprise one of a diagonal scanning order and a vertical scanning order originating at a common position within the block. For example, the diagonal and vertical scanning orders may also overlap for the first two positions within either scanning order, as previously described.

In other examples, once again, the first scanning order and the second scanning order may each comprise one of a zig-zag scanning order, a horizontal scanning order, and a vertical scanning order originating at a common position within the block. Once again, for example, the common position may be the DC position, as previously described. The zig-zag and horizontal scanning orders may overlap for the first two positions within either scanning order, as also previously described.

To encode the scanning order information for the block if the position of any of the one or more coefficients within the block according to the first scanning order is different than the position of the respective coefficient within the block according to the second scanning order, entropy encoding unit 56 may be configured to determine whether the position of the last significant coefficient within the block according to the first scanning order corresponds to the common position.

Once again, to make this determination, entropy encoding unit 56 may be configured to encode a significant coefficient flag and a last significant coefficient flag for a coefficient within the block corresponding to the common position, using the techniques previously described. Specifically, entropy encoding unit 56 may be configured to determine whether the last significant coefficient flag for the coefficient indicates that the coefficient is the last significant coefficient within the block according to the first scanning order.

In the event the position of the last significant coefficient within the block according to the first scanning order corresponds to the common position, entropy encoding unit 56 may be configured to not encode any scanning order information for the block, i.e., the scanning order information may not be necessary to decode the block.

In the event the position of the last significant coefficient within the block according to the first scanning order does not correspond to the common position, entropy encoding unit 56 may be further configured to encode an indication of whether the first scanning order is the vertical scanning order using a first signal. For example, the first signal may comprise a first bin, the value of which indicates whether the first scanning order is the vertical scanning order.

In the event the first scanning order is not the vertical scanning order, entropy encoding unit 56 may be further configured to determine whether the position of the last significant coefficient within the block according to the first scanning order corresponds to a next position within the block following the common position according to the zig-zag and the horizontal scanning orders.

Once again, to make this determination, entropy encoding unit 56 may be configured to encode a significant coefficient flag and a last significant coefficient flag for a coefficient within the block corresponding to the next position, using the techniques previously described. Specifically, entropy encoding unit 56 may be configured to determine whether the last significant coefficient flag for the coefficient indicates that the coefficient is the last significant coefficient within the block according to the first scanning order.

In the event the position of the last significant coefficient within the block according to the first scanning order corresponds to the next position, entropy encoding unit 56 may be configured to not encode any additional scanning order information for the block, i.e., no additional scanning order information may be necessary to decode the block.

Finally, in the event the position of the last significant coefficient within the block according to the first scanning order does not correspond to the next position, entropy encoding unit 56 may be further configured to encode an indication of whether the first scanning order is the zig-zag scanning order or the horizontal scanning order using a second signal, wherein the second signal is different than the first signal. For example, the second signal may comprise a second bin, the value of which indicates whether the first scanning order is the zig-zag scanning order or the horizontal scanning order.

In a similar manner as described above, in other examples, the first scanning order and the second scanning order may each comprise one of a diagonal scanning order, a horizontal scanning order, and a vertical scanning order originating at a common position within the block. For example, the diagonal and vertical scanning orders may also overlap for the first two positions within either scanning order, as previously described.

In any case, as previously described, after the significant coefficient flags and the last significant coefficient flags, i.e., the SM data for the block, and, in some cases, the scanning order information for the block, are encoded in the manner described above, the value of each significant coefficient (i.e., each significant coefficient's magnitude and sign, e.g., indicated by syntax elements “coeff_abs_level_minus1” and “coeff_sign_flag,” respectively) within the block may also be encoded.

As such, the techniques of this disclosure may enable entropy encoding unit 56 to encode the scanning order information for the block more efficiently than when using other methods. In this manner, there may be a relative bit savings for a coded bitstream including the scanning order information when using the techniques of this disclosure.

Inverse quantization unit 58 and inverse transform module 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in memory 64. The reconstructed video block may be used by motion estimation unit 42 and motion compensation unit 44 as a reference block to inter-code a block in a subsequent video frame.

In this manner, video encoder 20 represents an example of a video coder configured to code information that identifies a first scanning order associated with a block of video data if a position of any of one or more coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order, and avoid coding the information that identifies the first scanning order if the position of each of the one or more of the coefficients within the block according to the first scanning order is the same as the position of the respective coefficient within the block according to the second scanning order.

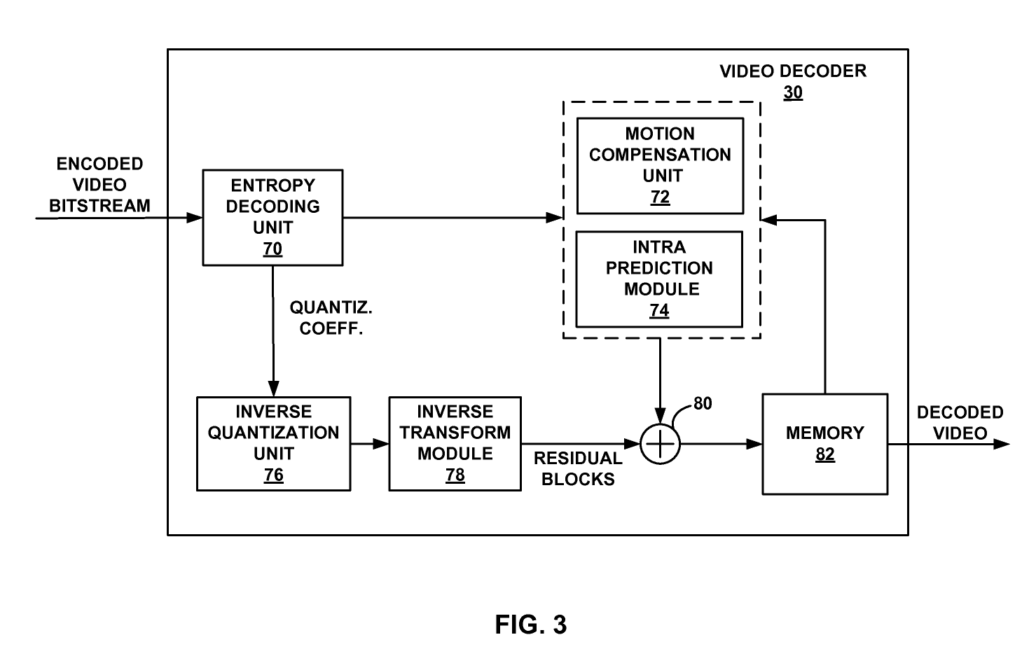

FIG. 3 is a block diagram that illustrates an example of a video decoder 30 that may implement techniques for efficiently decoding encoded scanning order information for a block of video data, consistent with the techniques of this disclosure. In the example of FIG. 3, video decoder 30 includes an entropy decoding unit 70, motion compensation unit 72, intra-prediction module 74, inverse quantization unit 76, inverse transform module 78, memory 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70.

For example, video decoder 30 may be configured to receive encoded video data (e.g., one or more macroblocks, or TUs of a CU) from video encoder 20. In accordance with the techniques of this disclosure, as one example, entropy decoding unit 70 may be configured to decode information that identifies a first scanning order associated with a block of video data, i.e., scanning order information for the block, if a position of any of one or more coefficients within the block, starting with a first coefficient within the block according to the first scanning order and ending with a last significant coefficient within the block according to the first scanning order, and proceeding according to the first scanning order, according to the first scanning order is different than a position of the respective coefficient within the block according to a second scanning order, wherein the second scanning order is different than the first scanning order. Entropy decoding unit 70 may be further configured to avoid decoding the scanning order information for the block if the position of each of the one or more coefficients within the block according to the first scanning order is the same as the position of the respective coefficient within the block according to the second scanning order.

In some examples, once again, the first scanning order and the second scanning order may each comprise one of a zig-zag scanning order and a horizontal scanning order originating at a common position within the block. Once again, for example, the common position may be the DC position, as previously described. The zig-zag and horizontal scanning orders may overlap for the first two positions within either scanning order, as also previously described.

To decode the scanning order information for the block if the position of any of the one or more coefficients within the block according to the first scanning order is different than the position of the respective coefficient within the block according to the second scanning order, entropy decoding unit 70 may be configured to receive a signal that indicates the scanning order information for the block when the position of the last significant coefficient within the block according to the first scanning order does not correspond to the common position, or to a next position within the block following the common position according to the zig-zag and the horizontal scanning orders.

For example, entropy decoding unit 70 may be configured to expect to receive the signal based on values of previously decoded significant coefficient flags and last significant coefficient flags for coefficients within the block corresponding to the common position and the next position, e.g., received from video encoder 20, using the techniques previously described. Specifically, entropy decoding unit 70 may be configured to receive the signal when the last significant coefficient flags for both coefficients indicate that neither coefficient is the last significant coefficient within the block according to the first scanning order.

Entropy decoding unit 70 may be further configured to decode the signal to determine whether the first scanning order is the zig-zag scanning order or the horizontal scanning order. For example, entropy decoding unit 70 may be configured to decode the signal to determine a single bin, and to determine whether the first scanning order is the zig-zag scanning order or the horizontal scanning order based on the value of the single bin.

In a similar manner as described above, in other examples, the first scanning order and the second scanning order may each comprise one of a diagonal scanning order and a vertical scanning order originating at a common position within the block. For example, the diagonal and vertical scanning orders may also overlap for the first two positions within either scanning order, as previously described.

In other examples, once again, the first scanning order and the second scanning order may each comprise one of a zig-zag scanning order, a horizontal scanning order, and a vertical scanning order originating at a common position within the block. Once again, for example, the common position may be the DC position, as previously described. The zig-zag and horizontal scanning orders may overlap for the first two positions within either scanning order, as also previously described.

To decode the scanning order information for the block if the position of any of the one or more coefficients within the block according to the first scanning order is different than the position of the respective coefficient within the block according to the second scanning order, entropy decoding unit 70 may be configured to receive a first signal that indicates the scanning order information for the block when the position of the last significant coefficient within the block according to the first scanning order does not correspond to the common position.

For example, entropy decoding unit 70 may be configured to expect to receive the first signal based on values of previously decoded significant coefficient flag and last significant coefficient flag for the coefficient within the block corresponding to the common position received from, e.g., video encoder 20, using the techniques previously described. Specifically, entropy decoding unit 70 may be configured to receive the first signal when the last significant coefficient flag for the coefficient indicates that the coefficient is not the last significant coefficient within the block according to the first scanning order.

Entropy decoding unit 70 may be further configured to decode the first signal to determine whether the first scanning order is the vertical scanning order. For example, entropy decoding unit 70 may be configured to decode the first signal to determine a first bin, and to determine whether the first scanning order is the vertical scanning order based on the value of the first bin. In the event the first scanning order is the vertical scanning order, no additional scanning order information for the block may be necessary for video decoder 30 to decode the block. Accordingly, in this case, entropy decoding unit 70 may not receive any additional scanning order information for the block beyond the first signal.

In the event the first scanning order is not the vertical scanning order, entropy decoding unit 70 may be further configured to receive a second, different signal that indicates the scanning order information for the block when the position of the last significant coefficient within the block according to the first scanning order does not correspond to a next position within the block following the common position according to the zig-zag and the horizontal scanning orders.

For example, entropy decoding unit 70 may be configured to expect to receive the second signal based on values of previously decoded significant coefficient flag and last significant coefficient flag for the coefficient within the block corresponding to the next position received from, e.g., video encoder 20, using the techniques previously described. Specifically, entropy decoding unit 70 may be configured to receive the second signal when the last significant coefficient flag for the coefficient indicates that the coefficient is not the last significant coefficient within the block according to the first scanning order.

Finally, entropy decoding unit 70 may be configured to decode the second signal to determine whether the first scanning order is the zig-zag scanning order or the horizontal scanning order. For example, entropy decoding unit 70 may be configured to decode the second signal to determine a second bin, and to determine whether the first scanning order is the zig-zag scanning order or the horizontal scanning order based on the value of the second bin.

In a similar manner as described above, in other examples, the first scanning order and the second scanning order may each comprise one of a diagonal scanning order, a horizontal scanning order, and a vertical scanning order originating at a common position within the block. For example, the diagonal and vertical scanning orders may also overlap for the first two positions within either scanning order, as previously described.

In any case, as previously described, after the significant coefficient flags and the last significant coefficient flags, i.e., the SM data for the block, and, in some cases, the scanning order information for the block, are decoded in the manner described above, the value of each significant coefficient (i.e., each significant coefficient's magnitude and sign, e.g., indicated by syntax elements “coeff_abs_level_minus1” and “coeff_sign_flag,” respectively) within the block may also be decoded.

As such, the techniques of this disclosure may enable entropy decoding unit 70 to decode the scanning order information for the block more efficiently than when using other methods. In this manner, there may be a relative bit savings for a coded bitstream including the scanning order information when using the techniques of this disclosure.

Motion compensation unit 72 may use motion vectors received in the bitstream to identify a prediction block in reference frames in memory 82. Intra-prediction module 74 may use intra-prediction modes received in the bitstream to form a prediction block from spatially adjacent blocks.

Intra-prediction module 74 may use an indication of an intra-prediction mode for the encoded block to intra-predict the encoded block, e.g., using pixels of neighboring, previously decoded blocks. For examples in which the block is inter-prediction mode encoded, motion compensation unit 72 may receive information defining a motion vector, in order to retrieve motion compensated prediction data for the encoded block. In any case, motion compensation unit 72 or intra-prediction module 74 may provide information defining a prediction block to summer 80.

Inverse quantization unit 76 inverse quantizes, i.e., de-quantizes, the quantized block coefficients provided in the bitstream and decoded by entropy decoding unit 70. The inverse quantization process may include a conventional process, e.g., as defined by the H.264 decoding standard or as performed by the HEVC Test Model. The inverse quantization process may also include use of a quantization parameter QP_{Y} calculated by video encoder 20 for each block to determine a degree of quantization and, likewise, a degree of inverse quantization that should be applied.

Inverse transform module 78 applies an inverse transform, e.g., an inverse DCT, an inverse integer transform, or a conceptually similar inverse transform process, to the transform coefficients in order to produce residual blocks in the pixel domain. Motion compensation unit 72 produces motion compensated blocks, possibly performing interpolation based on interpolation filters. Identifiers for interpolation filters to be used for motion estimation with sub-pixel precision may be included in the syntax elements. Motion compensation unit 72 may use interpolation filters as used by video encoder 20 during encoding of the video block to calculate interpolated values for sub-integer pixels of a reference block. Motion compensation unit 72 may determine the interpolation filters used by video encoder 20 according to received syntax information and use the interpolation filters to produce predictive blocks.

Motion compensation unit 72 uses some of the syntax information for the encoded block to determine sizes of blocks used to encode frame(s) of the encoded video sequence, partition information that describes how each block of a frame or slice of the encoded video sequence is partitioned, modes indicating how each partition is encoded, one or more reference frames (and reference frame lists) for each inter-encoded block or partition, and other information to decode the encoded video sequence. Intra-prediction module 74 may also use the syntax information for the encoded block to intra-predict the encoded block, e.g., using pixels of neighboring, previously decoded blocks, as described above.

Summer 80 sums the residual blocks with the corresponding prediction blocks generated by motion compensation unit 72 or intra-prediction module 74 to form decoded blocks. If desired, a deblocking filter may also be applied to filter the decoded blocks in order to remove blockiness artifacts. The decoded video blocks are then stored in memory 82, which provides reference blocks for subsequent motion compensation and also produces decoded video for presentation on a display device (such as display device 32 of FIG. 1).

In this manner, video decoder 30 represents an example of a video coder configured to code information that identifies a first scanning order associated with a block of video data if a position of any of one or more coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order, and avoid coding the information that identifies the first scanning order if the position of each of the one or more of the coefficients within the block according to the first scanning order is the same as the position of the respective coefficient within the block according to the second scanning order.

FIGS. 4A-4C are conceptual diagrams that illustrate an example of a block of video data and corresponding significant coefficient position information and last significant coefficient position information. As shown in FIG. 4A, a block of video data, e.g., a macroblock, or a TU of a CU, may include quantized transform coefficients. For example, as shown in FIG. 4A, block 400 may include quantized transform coefficients generated using prediction, transform, and quantization techniques previously described. Assume, for this example, that block 400 has a size of 2N×2N, wherein N equals to two. Accordingly, block 400 has a size of 4×4, and includes sixteen quantized transform coefficients, as also shown in FIG. 4A. Assume further, that the scanning order associated with block 400 is the zig-zag scanning order, as shown in FIG. 5A described in greater detail below.

In this example, a last significant coefficient within block 400 according to the zig-zag scanning order is a quantized transform coefficient equal to “1,” located in position 406 within block 400. In other examples, as described above, a block may have a size that is smaller or larger than the size of block 400, and may include more or fewer quantized transform coefficients than block 400. In still other examples, the scanning order associated with block 400 may be a different scanning order, e.g., a horizontal scanning order, a vertical scanning order, a diagonal scanning order, or another scanning order.

FIG. 4B illustrates an example of significant coefficient flag data, i.e., significant coefficient flags represented in map, or block form, as previously described. In the example of FIG. 4B, block 402 may correspond to block 400 depicted in FIG. 4A. In other words, the significant coefficient flags of block 402 may correspond to the quantized transform coefficients of block 400. As shown in FIG. 4B, the significant coefficient flags of block 402 that are equal to “1” correspond to significant coefficients of block 400. Similarly, the significant coefficient flags of block 402 that are equal to “0” correspond to zero, or non-significant coefficients of block 400.

In this example, a significant coefficient flag of block 402 corresponding to the last significant coefficient within block 400 according to the zig-zag scanning order is a significant coefficient flag equal to “1,” located in position 408 within block 402. In other examples, the values of significant coefficient flags used to indicate significant or non-significant coefficients may vary (e.g., significant coefficient flags equal to “0” may correspond to significant coefficients, and significant coefficient flags equal to “1” may correspond to non-significant coefficients).

FIG. 4C illustrates an example of last significant coefficient flag data, i.e., last significant coefficient flags represented in map, or block form, as also previously described. In the example of FIG. 4C, block 404 may correspond to block 400 and block 402 depicted in FIG. 4A and FIG. 4B, respectively. In other words, the last significant coefficient flags of block 404 may correspond to the quantized transform coefficients of block 400, and to the significant coefficient flags of block 402.

As shown in FIG. 4C, the last significant coefficient flag of block 404 that is equal to “1,” located in position 410 within block 404, corresponds to a last significant coefficient of block 400, and to a last one of the significant coefficient flags of block 402 that are equal to “1,” according to the zig-zag scanning order. Similarly, the last significant coefficient flags of block 404 that are equal to “0” (i.e., all remaining last significant coefficient flags) correspond to zero, or non-significant coefficients of block 400, and to all significant coefficient flags of block 402 that are equal to “1” other than the last one of such significant coefficient flags according to the zig-zag scanning order.

The values of the last significant coefficient flags used to indicate a last significant coefficient according to a scanning order may vary (e.g., a last significant coefficient flag equal to “0” may correspond to a last significant coefficient according to the scanning order, and last significant coefficient flags equal to “1” may correspond to all remaining coefficients). In any case, the significant coefficient flags of block 402, and the last significant coefficient flags of block 404, may be collectively referred to as SM data for block 400.

As described above, significant coefficient position information for a block of video data may be indicated by serializing significant coefficient flags for the block from a two-dimensional block representation, as depicted in block 402 shown in FIG. 4B, into a one-dimensional array, using a scanning order associated with the block. In the example of blocks 400-402 shown in FIGS. 4A-4B, again assuming the zig-zag scanning order, the significant coefficient position information for block 400 may be indicated by serializing the significant coefficient flags of block 402 into a one-dimensional array. That is, the significant coefficient position information for block 400 may be indicated by generating a sequence of significant coefficient flags of block 402 according to the zig-zag scanning order.

In this example, the generated sequence may correspond to a value “111111,” representing the first 6 significant coefficient flags of block 402 according to the zig-zag scanning order. It should be noted that the generated sequence may contain significant coefficient flags corresponding to a range of block positions within block 400, starting from a first block position in the zig-zag scanning order (i.e., the DC position) and ending with a block position corresponding to the last significant coefficient of block 400 according to the zig-zag scanning order (i.e., corresponding to the last significant coefficient flag equal to “1” of block 404).

As also described above, last significant coefficient position information for the block may be indicated by serializing last significant coefficient flags for the block from a two-dimensional block representation, as depicted in block 404 shown in FIG. 4C, into a one-dimensional array, using a scanning order associated with the block. In the example of blocks 400-404 shown in FIGS. 4A-4C, again assuming the zig-zag scanning order, the last significant coefficient position information for block 400 may be indicated by serializing the last significant coefficient flags of block 404 into a one-dimensional array. That is, the last significant coefficient position information for block 400 may be indicated by generating a sequence of last significant coefficient flags of block 404 according to the zig-zag scanning order. In this example, the generated sequence may correspond to a value “000001,” representing the first 6 last significant coefficient flags of block 404 according to the zig-zag scanning order.

Once again, it should be noted that the generated sequence may contain last significant coefficient flags corresponding to a range of block positions within block 400, starting from the first block position in the zig-zag scanning order, and ending with the block position corresponding to the last significant coefficient of block 400 according to the zig-zag scanning order (i.e., corresponding to the last significant coefficient flag equal to “1” of block 404). Accordingly, in this example, no last significant coefficient flags following the last significant coefficient flag equal to “1” according to the zig-zag scanning order are included in the sequence. Generally speaking, last significant coefficient flags following a last significant coefficient flag equal to “1” according to a scanning order associated with a block of video data may not be needed to indicate last significant coefficient position information for the block. As such, in some examples, these flags are omitted from the generated sequence of last significant coefficient flags used to indicate the information.

It should also be noted that, as described above, if the last significant coefficient is located within a last block position according to the scanning order (e.g., the bottom right block position), the generated sequence may not include a last significant coefficient flag corresponding to the last block position, because the position may be inferred to contain the last significant coefficient for the block. Accordingly, in this example, the generated sequence may correspond to a value “000000000000000,” wherein the last significant coefficient flag corresponding to the last block position is not included in the sequence, and is inferred to equal “1.”

FIGS. 5A-5C are conceptual diagrams that illustrate examples of blocks of video data scanned using a zig-zag scanning order, a horizontal scanning order, and a vertical scanning order, respectively. As shown in FIGS. 5A-5C, an 8×8 block of video data, e.g., a macroblock, or a TU of a CU, may include sixty-four quantized transform coefficients in corresponding block positions, denoted with circles. For example, blocks 500-504 may each include sixty-four quantized transform coefficients generated using prediction, transform, and quantization techniques previously described, again, wherein each corresponding block position is denoted with a circle. Assume, for this example, that blocks 500-504 have a size of 2N×2N, wherein N equals to four. Accordingly, blocks 500-504 have a size of 8×8.

As shown in FIG. 5A, the scanning order associated with block 500 is the zig-zag scanning order. The zig-zag scanning order scans the quantized transform coefficients of block 500 in a diagonal manner as indicated by the arrows in FIG. 5A. Similarly, as shown in FIGS. 5B and 5C, the scanning orders associated with blocks 502 and 504 are the horizontal scanning order and the vertical scanning order, respectively. The horizontal scanning order scans the quantized transform coefficients of block 502 in a horizontal line-by-line, or “raster” manner, while the vertical scanning order scans the quantized transform coefficients of block 504 in a vertical line-by-line, or “rotated raster” manner, also as indicated by the arrows in FIGS. 5B and 5C.

In other examples, as described above, a block may have a size that is smaller or larger than the size of blocks 500-504, and may include more or fewer quantized transform coefficients and corresponding block positions. In these examples, a scanning order associated with the block may scan the quantized transform coefficients of the block in a substantially similar manner as shown in the examples of 8×8 blocks 500-504 of FIGS. 5A-5C, e.g., a 4×4 block, or a 16×16 block, may be scanned following any of the scanning orders previously described.

As previously described, the techniques of this disclose may also apply with respect to a wide variety of other scanning orders, including a diagonal scanning order, scanning orders that are combinations of zigzag, horizontal, vertical, and/or diagonal scanning orders, as well as scanning orders that are partially zigzag, partially horizontal, partially vertical, and/or partially diagonal. In addition, the techniques of this disclosure may also consider a scanning order that is itself adaptive based on statistics associated with previously coded blocks of video data (e.g., blocks having the same block size or coding mode as the current block being coded). For example, an adaptive scanning order could be the scanning order associated with a block of video data, in some cases.

FIGS. 6A-6C are conceptual diagrams that illustrate additional examples of blocks of video data scanned using a zig-zag scanning order, a horizontal scanning order, and a vertical scanning order. As shown in FIG. 6A, block 600 may include sixteen block positions ordered from 0 to 15 according to the zig-zag scanning order, as indicated by the arrows, and described above with reference to FIG. 5A. Each of the sixteen block positions may contain a quantized transform coefficient, as described above with reference to FIG. 4A. As also shown in FIG. 6A, the first and second positions within block 600 according to the zig-zag scanning order, corresponding to positions “0” and “1,” may be referred to as common position 606 and common position 608, respectively. In some examples, one or more of common positions 606, 608 may coincide with first and second block positions within another block of video data according to another scanning order, as described in greater detail below.

As one example, as shown in FIG. 6B, block 602 may also include sixteen block positions, once again ordered from 0 to 15, although, in this case, according to a horizontal scanning order, as indicated by the arrows, and described above with reference to FIG. 5B. Each of the sixteen block positions may contain a quantized transform coefficient, as described above with reference to FIG. 4A. As also shown in FIG. 6B, the first and second positions within block 602 according to the horizontal scanning order, corresponding to positions “0” and “1,” may be referred to as common position 610 and common position 612, respectively. As shown in FIGS. 6A-6B, common positions 610, 612 within block 602 may coincide with common positions 606, 608 within block 600.

As another example, as shown in FIG. 6C, block 604 may once again include sixteen block positions, also ordered from 0 to 15, although, in this case, according to a vertical scanning order, as indicated by the arrows, and described above with reference to FIG. 5C. Each of the sixteen block positions may contain a quantized transform coefficient, as described above with reference to FIG. 4A. As shown in FIG. 6C, the first block position within block 604 according to the vertical scanning order, corresponding to position 0, may be referred to as common position 614. As shown in FIGS. 6A-6C, common position 614 within block 604 may coincide with common position 606 within block 600, and common position 610 within block 602.

In other words, as shown in FIGS. 6A-6C, in examples where the scanning order is one of the zig-zag scanning order, the horizontal scanning order, and the vertical scanning order, common positions 606, 610, 614 have a same designation, e.g., same position number, within their respective blocks according to their respective scanning orders. For example, each of common positions 606, 610, 614 may be referred to as the DC position within its respective block. Similarly, in examples where the scanning order is one of the zig-zag scanning order and the horizontal scanning order, common positions 608, 612 also a have a same designation within their respective blocks according to their respective scanning orders. For example, each of common positions 608, 612 may be referred to as the next position following the DC position according to the zig-zag and the horizontal scanning orders within its respective block.

As shown by FIGS. 6A-6B, in examples where the scanning order is one of the zig-zag scanning order and the horizontal scanning order, and the last significant coefficient is located in common positions 606-612, the scanning order information for the respective block need not be encoded by video encoder 20, as it is not needed by video decoder 30 to decode the block. For example, for any one of blocks 600-602, entropy encoding unit 56 may encode significant coefficient and last significant coefficient flags for the quantized transform coefficient located in the respective one of common positions 606, 610, and for the quantized transform coefficient located in the respective one of common positions 608, 612. In the event one such last significant coefficient flag for either coefficient indicates that the coefficient is the last significant coefficient within the respective block according to the scanning order associated with the block, entropy encoding unit 56 may avoid coding the scanning order information for the block. In the event none of the coefficients for the respective block is the last significant coefficient, entropy encoding unit 56 may encode the scanning order information for the block, and proceed to encode significant coefficient and last significant coefficient flags for the remaining coefficients within the block, as previously described.

Similarly, as shown by FIGS. 6A-6C, in examples where the scanning order is one of the zig-zag scanning order, the horizontal scanning order, and the vertical scanning order, and the last significant coefficient is located in common positions 606, 610, and 614, the scanning order information for the respective block need not be encoded by video encoder 20, as it is not needed by video decoder 30 to decode the block. For example, for any one of blocks 600-604, entropy encoding unit 56 may encode significant coefficient and last significant coefficient flags for the quantized transform coefficient located in the respective one of common positions 606, 610, 614. In the event one such last significant coefficient flag indicates that the corresponding coefficient is the last significant coefficient within the respective block according to the scanning order associated with the block, entropy encoding unit 56 may avoid coding the scanning order information for the block.

In the event the coefficient is not the last significant coefficient, entropy encoding unit 56 may proceed to encode the scanning order information for the block in an incremental manner, to the extent necessary for entropy decoding unit 70 to decode the block. For example, entropy encoding unit 56 may encode a first signal that indicates whether the scanning order is a vertical scanning order. In the event the scanning order is the vertical scanning order, entropy encoding unit 56 may not encode any further scanning order information for the block. In the event the scanning order is not the vertical scanning order, entropy encoding unit 56 may encode significant coefficient and last significant coefficient flags for the quantized transform coefficient located in the respective one of common positions 608, 612. In the event one such last significant coefficient flag indicates that the corresponding coefficient is the last significant coefficient within the respective block according to the scanning order associated with the block, entropy encoding unit 56 may avoid coding any further scanning order information for the block.

In the event the coefficient is not the last significant coefficient, entropy encoding unit 56 may proceed to encode the exact scanning order information for the block, and proceed to encode significant coefficient and last significant coefficient flags for the remaining coefficients within the block, as also previously described.

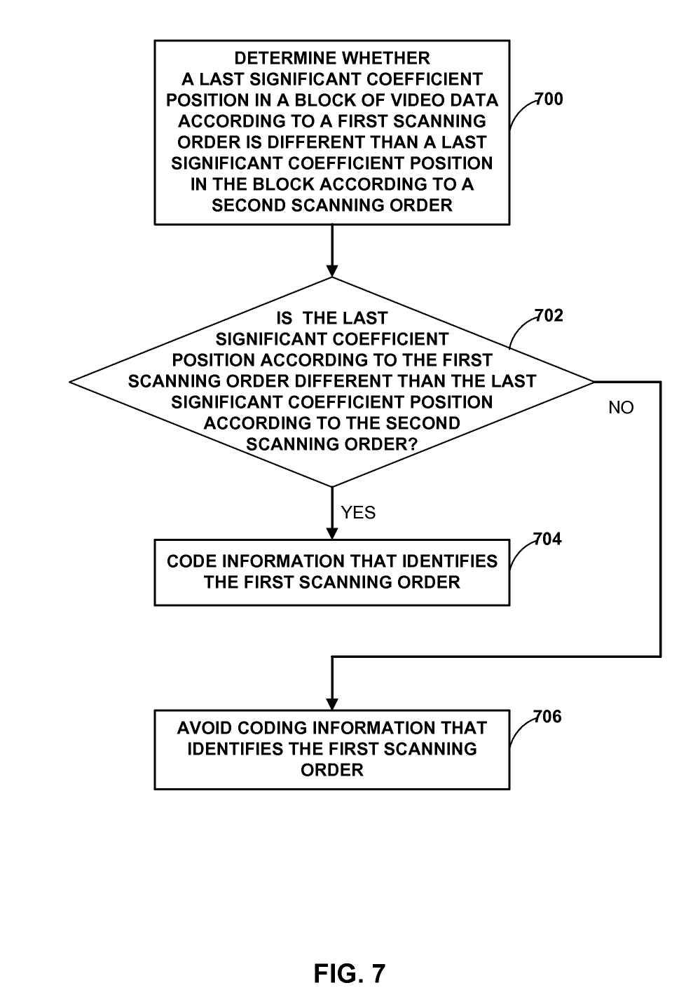

FIG. 7 is a flowchart that illustrates an example of a method for efficiently coding scanning order information for a block of video data, consistent with the techniques of this disclosure. The techniques of FIG. 7 may generally be performed by any processing unit or processor, whether implemented in hardware, software, firmware, or a combination thereof, and when implemented in software or firmware, corresponding hardware may be provided to execute instructions for the software or firmware. For purposes of example, the techniques of FIG. 7 are described with respect to video encoder 20 (FIGS. 1 and 2) and/or video decoder 30 (FIGS. 1 and 3), although it should be understood that other devices may be configured to perform similar techniques. Moreover, the steps illustrated in FIG. 7 may be performed in a different order or in parallel, and additional steps may be added and certain steps omitted, without departing from the techniques of this disclosure.

Initially, video encoder 20 and/or video decoder 30 may determine whether a position of a last significant coefficient within a block of video data according to a first scanning order associated with the block is different than a position of a last significant coefficient within the block according to a second scanning order (700). For example, the block may be a macroblock, or a TU of a CU, as previously described. Furthermore, the first scanning order associated with the block and the second scanning order each may include one of a zig-zag scanning order, a horizontal scanning order, and a vertical scanning order originating at a common position within the block, e.g., the DC position, as also previously described.

Specifically, the first scanning order associated with the block may be a scanning order used by video encoder 20 to encode the block. The second scanning order may be any scanning order other than the first scanning order that may have been used by video encoder 20 to encode the block in the corresponding coding system 10 comprising video encoder 20 and video decoder 30, i.e., any scanning order other than the first scanning order that is also used by system 10 to code blocks of video data. In this manner, the example method of FIG. 7 may be applicable to any coding system that uses a plurality of scanning orders to code blocks of video data.

For example, to determine whether the position of the last significant coefficient within the block according to the first scanning order is different than the position of the last significant coefficient within the block according to the second scanning order, video encoder 20 and/or video decoder 30 may determine whether the position of the last significant coefficient within the block according to the first scanning order corresponds to the common position. In some examples, the common position may be the DC position, as previously described.

For example, video encoder 20 may determine whether the position of the last significant coefficient within the block according to the first scanning corresponds to the common position as part of encoding the block. In this example, video encoder 20 may encode a significant coefficient flag and a last significant coefficient flag for a coefficient within the block corresponding to the common position, as previously described.

As another example, video decoder 30 may determine whether the position of the last significant coefficient within the block according to the first scanning order corresponds to the common position using syntax information received for the block, e.g., a significant coefficient flag and a last significant coefficient flag for the coefficient within the block corresponding to the common position. Specifically, video decoder 30 may make this determination based on the last significant coefficient flag for the coefficient that indicates whether the coefficient is the last significant coefficient within the block according to the first scanning order, as also previously described.

In any case, in the event the position of the last significant coefficient within the block according to the first scanning order is different than the position of the last significant coefficient within the block according to the second scanning order (702), video encoder 20 and/or video decoder 30 may further code information that identifies the first scanning order (704), i.e., scanning order information for the block. For example, the scanning order information for the block may be encoded in the case of video encoder 20, and decoded in the case of video decoder 30.

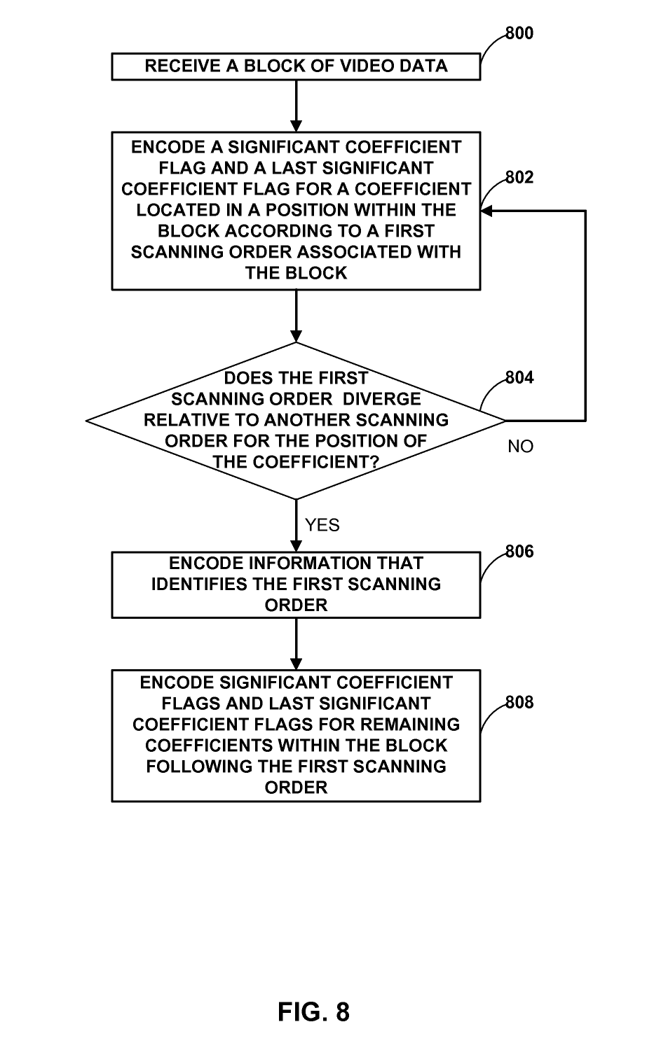

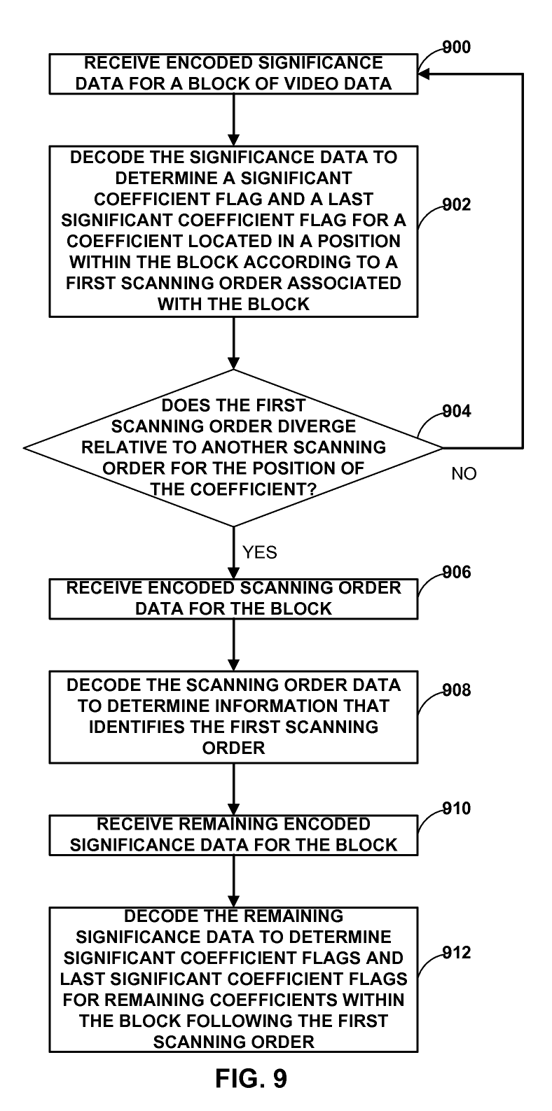

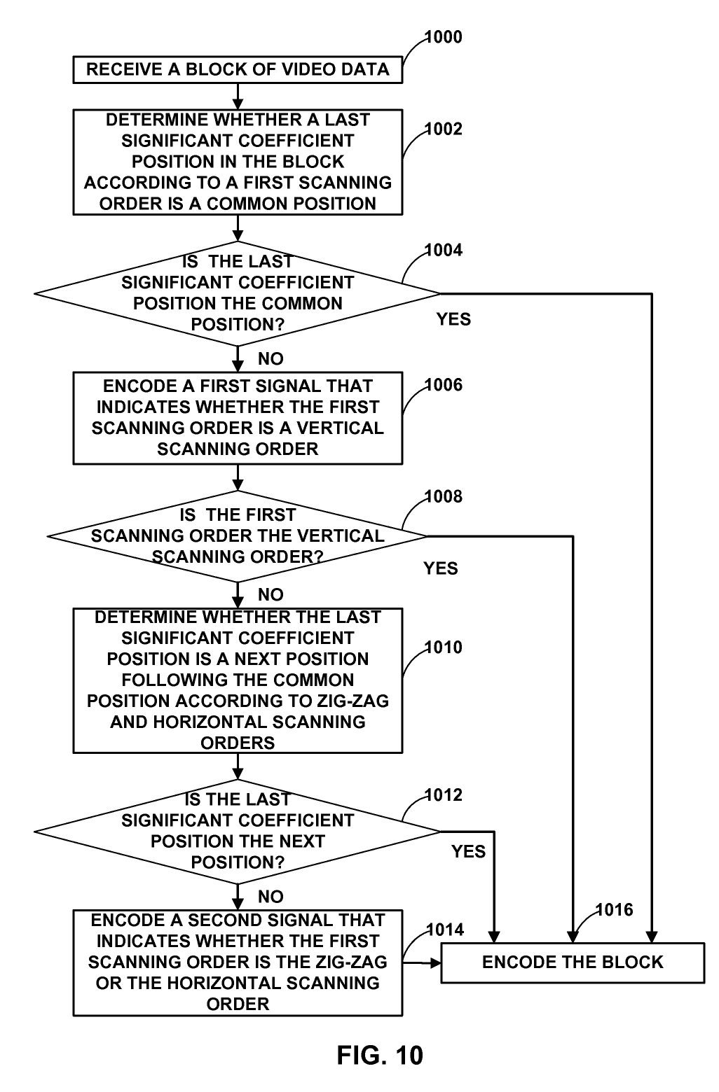

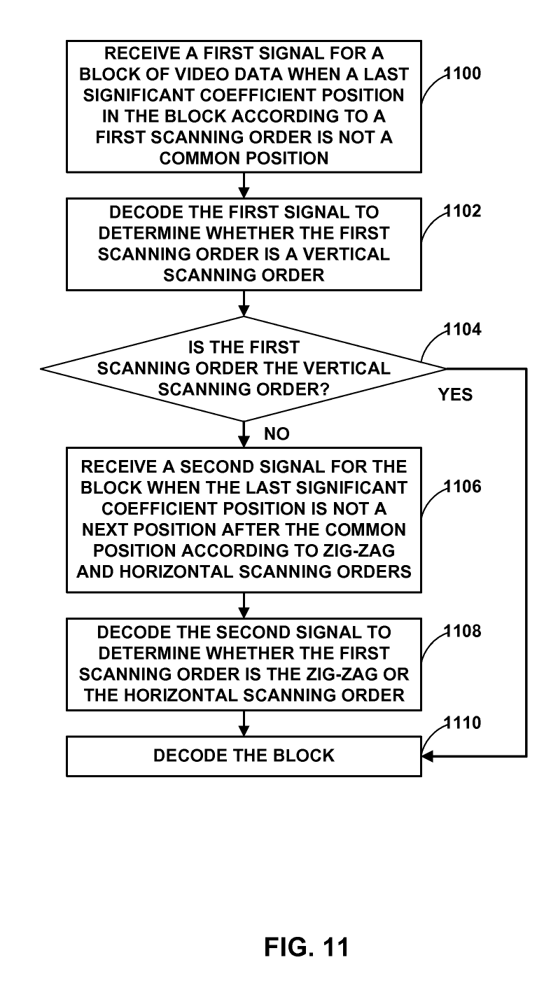

In some examples, such as the examples of FIGS. 8-9 described in greater detail below, where the first scanning order and the second scanning order each may include one of the zig-zag scanning order and the horizontal scanning order, the scanning order information may be coded using a single bit, or “bin,” to indicate the first scanning order. For example, the single bin may be coded to indicate whether the first scanning order is the zig-zag scanning order (e.g., bin=“0”) or the horizontal scanning order (bin=“1”). In other examples, such as the examples of FIGS. 10-11 also described in greater detail below, where the first scanning order and the second scanning order each may include one of the zig-zag scanning order, the horizontal scanning order, and the vertical scanning order, the scanning order information may be coded using between one and two bins to indicate the first scanning order. For example, a first bin may be coded to indicate whether the first scanning order is the vertical scanning order (e.g., bin1=“0” if the first scanning order is the vertical scanning order, and bin1=“1” otherwise). In the event the first bin indicates that the first scanning order is not the vertical scanning order, a second bin may be coded to indicate whether the first scanning order is the zig-zag scanning order (e.g., bin2=“0”), or the horizontal scanning order (e.g., bin2=“1”).

In the event the position of the last significant coefficient within the block according to the first scanning order is not different than the position of the last significant coefficient within the block according to the second scanning order (702), however, video encoder 20 and/or video decoder 30 may avoid coding the information that identifies the first scanning order (706). In other words, in the event the position of the last significant coefficient within the block according to the first scanning order is the same as a position of a last significant coefficient within the block according to any scanning order other than the first scanning order that may have been used by video encoder 20 to encode the block, video encoder 20 and/or video decoder 30 may be configured to avoid coding the scanning order information for the block. As previously described, in such cases, the scanning order information is not necessary for video decoder 30 to decode the block.

In this manner, the method of FIG. 7 represents an example of a method of coding information that identifies a first scanning order associated with a block of video data if a position of any of one or more coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order, and avoiding coding the information that identifies the first scanning order if the position of each of the one or more of the coefficients within the block according to the first scanning order is the same as the position of the respective coefficient within the block according to the second scanning order.

FIG. 8 is a flowchart that illustrates an example of a method for efficiently encoding scanning order information for a block of video data, consistent with the techniques of this disclosure. Once again, the techniques of FIG. 8 may generally be performed by any processing unit or processor, whether implemented in hardware, software, firmware, or a combination thereof, and when implemented in software or firmware, corresponding hardware may be provided to execute instructions for the software or firmware. For purposes of example, the techniques of FIG. 8 are described with respect to entropy encoding unit 56 (FIG. 2), although it should be understood that other devices may be configured to perform similar techniques. Moreover, the steps illustrated in FIG. 8 may be performed in a different order or in parallel, and additional steps may be added and certain steps omitted, without departing from the techniques of this disclosure.

Initially, entropy encoding unit 56 may receive a block of video data (800). For example, the block may be a macroblock, or a TU of a CU, as previously described. Entropy encoding unit 56 may further encode a significant coefficient flag and a last significant coefficient flag for a coefficient located in a position within the block according to a first scanning order associated with the block (802). The first scanning order may include one of a zig-zag scanning order, a horizontal scanning order, and a vertical scanning order originating at the common position within the block, and may be a scanning order used by entropy encoding unit 56 to encode the block, as previously described. For example, the coefficient may be a first coefficient within the block according to the first scanning order, e.g., corresponding to the DC position within the block.

Entropy encoding unit 56 may further determine whether the first scanning order diverges relative to another scanning order for the position of the coefficient (804). For example, the other scanning order may include any scanning order other than the first scanning order that may have been used by entropy encoding unit 56 to encode the block in the corresponding coding system 10 comprising video encoder 20 and video decoder 30, as previously described. Furthermore, the first scanning order diverging relative to the other scanning order for the position of the coefficient may be indicated by the position having a different designation according to the first scanning order and the other scanning order.

In the event the first scanning order does not diverge relative to the other scanning order (804), entropy encoding unit 56 may repeat the steps described above by encoding a significant coefficient flag and a last significant coefficient flag for another coefficient located in another position, e.g., the next position, within the block according to the first scanning order (802). In other words, in the event the first scanning order does not diverge relative to the other scanning order, entropy encoding unit 56 may repeat the process until significant coefficient flags and last significant coefficient flags for every coefficient within the block are encoded.

In the event the first scanning order diverges relative to the other scanning order (804), however, entropy encoding unit 56 may proceed to encode information that indicates the first scanning order (806), i.e., the scanning order information for the block. For example, entropy encoding unit 56 may encode the information using a single bin, as previously described.

Finally, entropy encoding unit 56 may proceed to encode significant coefficient flags and last significant coefficient flags for the remaining coefficients within the block following the first scanning order (808). For example, to encode the significant coefficient flags and the last significant coefficient flags, entropy encoding unit 56 may perform the same process as described above with reference to step (802).

In this manner, the method of FIG. 8 represents an example of a method of coding information that identifies a first scanning order associated with a block of video data if a position of any of one or more coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order, and avoiding coding the information that identifies the first scanning order if the position of each of the one or more of the coefficients within the block according to the first scanning order is the same as the position of the respective coefficient within the block according to the second scanning order.

FIG. 9 is a flowchart that illustrates an example of a method for efficiently decoding encoded scanning order information for a block of video data, consistent with the techniques of this disclosure. Once again, the techniques of FIG. 9 may generally be performed by any processing unit or processor, whether implemented in hardware, software, firmware, or a combination thereof, and when implemented in software or firmware, corresponding hardware may be provided to execute instructions for the software or firmware. For purposes of example, the techniques of FIG. 9 are described with respect to entropy decoding unit 70 (FIG. 3), although it should be understood that other devices may be configured to perform similar techniques. Moreover, the steps illustrated in FIG. 9 may be performed in a different order or in parallel, and additional steps may be added and certain steps omitted, without departing from the techniques of this disclosure.

Initially, entropy decoding unit 70 may receive encoded significance data for a block of video data (900). For example, the block may be a macroblock, or a TU of a CU, as previously described. Entropy decoding unit 70 may further decode the significance data to determine a significant coefficient flag and a last significant coefficient flag for a coefficient located in a position within the block according to a first scanning order associated with the block (902). Once again, the first scanning order may be one of a zig-zag scanning order, a horizontal scanning order, and a vertical scanning order originating at the common position within the block, and may be a scanning order used by an entropy encoding unit, e.g., entropy encoding unit 56 of FIG. 2, to encode the block, as previously described. As also previously described, for example, the coefficient may be a first coefficient within the block according to the first scanning order, e.g., corresponding to the DC position within the block.

Entropy decoding unit 70 may further determine whether the first scanning order diverges relative to another scanning order for the position of the coefficient (904). Once again, for example, the other scanning order may include any scanning order other than the first scanning order that may have been used by the entropy encoding unit, e.g., entropy encoding unit 56, to encode the block, as previously described. As also previously described, the first scanning order diverging relative to the other scanning order for the position of the coefficient may be indicated by the position having a different designation according to the first scanning order and the other scanning order.

In the event the first scanning order does not diverge relative to the other scanning order (904), entropy decoding unit 70 may repeat the steps described above by receiving encoded significance data for the block (900), and decoding a significant coefficient flag and a last significant coefficient flag for another coefficient located in another position, e.g., the next position, within the block according to the first scanning order (902). In other words, in the event the first scanning order does not diverge relative to the other scanning order, entropy decoding unit 70 may repeat the process until significant coefficient flags and last significant coefficient flags for every coefficient within the block are decoded.

In the event the first scanning order diverges relative to the other scanning order (904), however, entropy decoding unit 70 may receive encoded scanning order data for the block (906). Entropy decoding unit 70 may further decode the scanning order data to determine information that indicates the first scanning order (908), i.e., the scanning order information for the block. For example, entropy decoding unit 70 may decode the scanning order data to generate one or more bins that indicate the information, as previously described.

Finally, entropy decoding unit 70 may receive remaining encoded significance data for the block (910). Entropy decoding unit 70 may further decode the remaining significance data to determine significant coefficient flags and last significant coefficient flags for the remaining coefficients within the block following the first scanning order (912). For example, to decode the remaining significance data, entropy decoding unit 70 may perform the same process as described above with reference to steps (900) and (902).

In this manner, the method of FIG. 9 represents an example of a method of coding information that identifies a first scanning order associated with a block of video data if a position of any of one or more of the coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order, and avoiding coding the information that identifies the first scanning order if the position of each of the one or more of the coefficients within the block according to the first scanning order is the same as the position of the respective coefficient within the block according to the second scanning order.

FIG. 10 is a flowchart that illustrates another example of a method for efficiently encoding scanning order information for a block of video data, consistent with the techniques of this disclosure. Once again, the techniques of FIG. 10 may generally be performed by any processing unit or processor, whether implemented in hardware, software, firmware, or a combination thereof, and when implemented in software or firmware, corresponding hardware may be provided to execute instructions for the software or firmware. For purposes of example, the techniques of FIG. 10 are described with respect to entropy encoding unit 56 (FIG. 2), although it should be understood that other devices may be configured to perform similar techniques. Moreover, the steps illustrated in FIG. 10 may be performed in a different order or in parallel, and additional steps may be added and certain steps omitted, without departing from the techniques of this disclosure.

Initially, entropy encoding unit 56 may receive a block of video data (1000). For example, the block may be a macroblock, or a TU of a CU, as previously described. Entropy encoding unit 56 may further determine whether a position of a last significant coefficient within the block according to a first scanning order associated with the block is a common position (1002). The first scanning order associated with the block may include one of a zig-zag scanning order, a horizontal scanning order, and a vertical scanning order originating at the common position within the block, and may be a scanning order used by entropy encoding unit 56 to encode the block, as previously described. As also previously described, the common position may be a position within the block that has a same designation according any one of the scanning orders that may have been used by entropy encoding unit 56 to encode the block, e.g., a same position number within the block according to any one of the scanning orders. In some examples, the common position may correspond to the DC position.

As previously described, entropy encoding unit 56 may determine whether the position of the last significant coefficient within the block according to the first scanning order is the common position by encoding a significant coefficient flag and a last significant coefficient flag for a coefficient within the block corresponding to the common position.

In the event the position of the last significant coefficient within the block according to the first scanning order is the common position (1004), entropy encoding unit 56 may proceed to encode the block (1016). For example, entropy encoding unit 56 may proceed to encode significant coefficient flags and last significant coefficient flags for the remaining coefficients within the block. In other words, entropy encoding unit 56 may avoid encoding information that identifies the first scanning order, i.e., the scanning order information for the block. In this example, because the last significant coefficient within the block according to the first scanning order is located in the common position, which, as described above, has the same designation according to any one of the scanning orders that may have been used by entropy encoding unit 56 to encode the block, the scanning order information for the block is not needed by video decoder 30 to decode the block, and, therefore, is not encoded by entropy encoding unit 56.

In the event the position of the last significant coefficient within the block according to the first scanning order is not the common position (1004), however, entropy encoding unit 56 may proceed to encode a first signal that indicates whether the first scanning order is the vertical scanning order (1006). For example, entropy encoding unit 56 may encode the first signal using a first bit, or “bin,” where the first bin being equal to “0” indicates that the first scanning order is the vertical scanning order, and the first bin being equal to “1” indicates otherwise (i.e., that the first scanning order is the zig-zag scanning order, or the horizontal scanning order).

Entropy encoding unit 56 encoding the first bin in this manner represents an incremental approach to coding the scanning order information for the block, consistent with the techniques of this disclosure. For example, encoding the first bin may be sufficient to provide the scanning order information for the block to video decoder 30 to be used to decode the block. As one such example, in the event the first scanning order is the vertical scanning order (1008) (e.g., bin1=“0”), entropy encoding unit 56 may proceed to encode the block (1016), e.g., by encoding significant coefficient flags and last significant coefficient flags for the remaining coefficients within the block. In this case, the scanning order information for the block is coded using only a single bin of data.

In other examples, entropy encoding unit 56 may perform further steps consistent with the incremental approach to coding the scanning order information for the block. For example, in the event the first scanning order is not the vertical scanning order (1008) (e.g., bin1=“1”), entropy encoding unit 56 may further determine whether the position of the last significant coefficient within the block according to the first scanning order is a next position within the block following the common position according to zig-zag and horizontal scanning orders (1010). In this example, the next position may be a position within the block located to the immediate right of the common position, as described above with reference to FIGS. 6A-6B.

As also previously described, entropy encoding unit 56 may determine whether the position of the last significant coefficient within the block according to the first scanning order is the next position by encoding a significant coefficient flag and a last significant coefficient flag for a coefficient within the block corresponding to the next position.

In the event the position of the last significant coefficient within the block according to the first scanning order is the next position (1012), entropy encoding unit 56 may proceed to encode the block (1016), e.g., once again, by encoding significant coefficient flags and last significant coefficient flags for the remaining coefficients within the block. In other words, entropy encoding unit 56 may avoid encoding any further scanning order information for the block beyond the first bin. In this case, because the last significant coefficient within the block according to the first scanning order is located in the next position, which, as described above, has the same designation according to the zig-zag and the horizontal scanning orders, no further scanning order information for the block, e.g., indicating the exact scanning order used by video encoder 20, is needed by video decoder 30 to decode the block. As such, entropy encoding unit 56 does not encode any further scanning order information for the block. In this case, the scanning order information for the block is coded using only a single bin of data, i.e., the first bin.

In the event the position of the last significant coefficient within the block according to the first scanning order is not the next position (1012), however, entropy encoding unit 56 may encode a second signal that indicates whether the first scanning order is the zig-zag scanning order or the horizontal scanning order (1014). For example, entropy encoding unit 56 may encode the second signal using a second bin, where the second bin being equal to “0” indicates that the first scanning order is the zig-zag scanning order, and the second bin being equal to “1” indicates that the first scanning order is the horizontal scanning order.

Entropy encoding unit 56 encoding the second bin in this manner further represents the incremental approach to coding the scanning order information for the block, consistent with the techniques of this disclosure. In this example, encoding the second bin may be necessary to provide the scanning order information for the block to video decoder 30 to be used to decode the block.

Finally, entropy encoding unit 56 may proceed to encode the block (1016) e.g., once again, by encoding significant coefficient flags and last significant coefficient flags for the remaining coefficients within the block. In this particular example, because the position of the last significant coefficient within the block according to the first scanning order does not correspond to the common position, or to the next position following the common position according to the zig-zag and the horizontal scanning orders, the scanning order information for the block is coded using two bins of data, i.e., the first bin, and the second bin.

In this manner, the method of FIG. 10 represents an example of a method of coding information that identifies a first scanning order associated with a block of video data if a position of any of one or more of the coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order, and avoiding coding the information that identifies the first scanning order if the position of each of the one or more of the coefficients within the block according to the first scanning order is the same as the position of the respective coefficient within the block according to the second scanning order.

FIG. 11 is a flowchart that illustrates another example of a method for efficiently decoding encoded scanning order information for a block of video data, consistent with the techniques of this disclosure. Once again, the techniques of FIG. 11 may generally be performed by any processing unit or processor, whether implemented in hardware, software, firmware, or a combination thereof, and when implemented in software or firmware, corresponding hardware may be provided to execute instructions for the software or firmware. For purposes of example, the techniques of FIG. 11 are described with respect to entropy decoding unit 70 (FIG. 3), although it should be understood that other devices may be configured to perform similar techniques. Moreover, the steps illustrated in FIG. 11 may be performed in a different order or in parallel, and additional steps may be added and certain steps omitted, without departing from the techniques of this disclosure.

Initially, entropy decoding unit 70 may receive a first signal that indicates scanning order information for a block of video data when a position of a last significant coefficient within the block according to a first scanning order associated with the block is not a common position (1100). Once again, for example, the block may be a macroblock, or a TU of a CU, as previously described. As also previously described, the first scanning order associated with the block may include one of a zig-zag scanning order, a horizontal scanning order, and a vertical scanning order originating at the common position within the block, e.g., the DC position. For example, the first scanning order may be a scanning order used by an entropy encoding unit, e.g., entropy encoding unit 56 of FIG. 2, to encode the block. Additionally, the common position may be a position within the block that has a same designation according to any one of the scanning orders that may have been used by the entropy encoding unit to encode the block, e.g., a same position number within the block according to any one of the scanning orders. Once again, in some examples, the common position may correspond to the DC position.

As previously described, entropy decoding unit 70 may expect to receive the first signal based on values of previously decoded significant coefficient flag and last significant coefficient flag for the coefficient within the block corresponding to the common position received from, e.g., video encoder 20, using the techniques previously described. Specifically, entropy decoding unit 70 may receive the first signal when the last significant coefficient flag for the coefficient indicates that the coefficient is not the last significant coefficient within the block according to the first scanning order.

Entropy decoding unit 70 may further decode the first signal to determine whether the first scanning order is a vertical scanning order (1102). For example, entropy decoding unit 70 may decode the first signal to determine a first bit, or “bin,” where the first bin being equal to “0” indicates that the first scanning order is the vertical scanning order, and the first bin being equal to “1” indicates otherwise (i.e., that the first scanning order is the zig-zag scanning order, or the horizontal scanning order).

Entropy decoding unit 70 receiving the first signal in this manner once again represents an incremental approach to coding the scanning order information for the block, consistent with the techniques of this disclosure. For example, decoding the first signal to determine the first bin may be sufficient to provide the scanning order information for the block to entropy decoding unit 70 to be used to decode the block. As one such example, in the event the first scanning order is the vertical scanning order (1104) (e.g., bin1=“0”), entropy decoding unit 70 may proceed to decode the block (1110). For example, entropy decoding unit 70 may proceed to decode significant coefficient flags and last significant coefficient flags for the remaining coefficients within the block. In this case, the scanning order information for the block is coded using only a single bin of data.

In other examples, entropy decoding unit 70 may perform further steps consistent with the incremental approach to coding the scanning order information for the block. For example, in the event the first scanning order is not the vertical scanning order (1104) (e.g., bin1=“1”), entropy decoding unit 70 may receive a second signal for the block when the position of the last significant coefficient within the block according to the first scanning order is not a next position following the common position according to zig-zag and horizontal scanning orders (1106). In this example, the next position may be a position within the block located to the immediate right of the common position, as described above with reference to FIGS. 6A-6B.

As also previously described, entropy decoding unit 70 may expect to receive the second signal based on values of previously decoded significant coefficient flag and last significant coefficient flag for the coefficient within the block corresponding to the next position received from, e.g., video encoder 20, using the techniques previously described. Specifically, entropy decoding unit 70 may receive the second signal when the last significant coefficient flag for the coefficient indicates that the coefficient is not the last significant coefficient within the block according to the first scanning order.

Entropy decoding unit 70 may further decode the second signal to determine whether the first scanning order is the zig-zag scanning order or the horizontal scanning order (1108). For example, entropy decoding unit 70 may decode the second signal to determine a second bin, where the second bin being equal to “0” indicates that the first scanning order is the zig-zag scanning order, and the second bin being equal to “1” indicates that the first scanning order is the horizontal scanning order.

Entropy decoding unit 70 receiving the second signal in this manner further represents the incremental approach to coding the scanning order information for the block, consistent with the techniques of this disclosure. In this example, decoding the second signal to determine the second bin may be necessary to provide the scanning order information for the block to entropy decoding unit 70 to be used to decode the block.

Finally, entropy decoding unit 70 may proceed to decode the block (1110), e.g., by decoding significant coefficient flags and last significant coefficient flags for the remaining coefficients within the block. In this particular example, because the position of the last significant coefficient within the block according to the first scanning order does not correspond to the common position, or to the next position following the common position according to the zig-zag and the horizontal scanning orders, the scanning order information for the block is coded using two bins of data, i.e., the first bin, and the second bin.

In this manner, the method of FIG. 11 represents an example of a method of coding information that identifies a first scanning order associated with a block of video data if a position of any of one or more of the coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order, and avoiding coding the information that identifies the first scanning order if the position of each of the one or more of the coefficients within the block according to the first scanning order is the same as the position of the respective coefficient within the block according to the second scanning order.

Therefore, in accordance with the techniques of this disclosure, an encoded bitstream may comprise scanning order information for a block of video data interspersed among significant coefficient flag and last significant coefficient flag data, i.e., SM data, for coefficients associated with the block. In particular, video encoder 20 may encode significant coefficient flags and last significant coefficient flags for one or more coefficients within the block according to the scanning order associated with the block, after which video encoder 20 may encode the scanning order information for the block. Subsequently, video encoder 20 may encode additional significant coefficient flags and last significant coefficient flags for additional one or more coefficients within the block according to the scanning order. Video decoder 30 may decode the significant coefficient flags and last significant coefficient flags, and based on the flags, decode the scanning order information for the block.

Accordingly, this disclosure also contemplates a computer-readable medium comprising a data structure stored thereon that includes an encoded bitstream. The encoded bitstream stored on the computer-readable medium may comprise video data encoded in a specific order, and information that identifies a first scanning order associated with a block of video data interspersed among significant coefficient flag and last significant coefficient flag data for coefficients associated with the block. The specific position of the scanning order information within the bitstream depends on whether a position of any of one or more of the coefficients within the block, starting with a first coefficient within the block according to the first scanning order and ending with a last significant coefficient within the block according to the first scanning order, and proceeding according to the first scanning order, according to the first scanning order is different than a position of the respective coefficient within the block according to a second scanning order, wherein the second scanning order is different than the first scanning order. If so, then the bitstream may include the significant coefficient flag and last significant coefficient flag data for coefficients for positions in the first and second scanning orders that coincide with one another (possibly for two or more positions), followed by the scanning order information, followed by significant coefficient flag and last significant coefficient flag data for the remaining coefficients associated with the block. If the position of each of the one or more of the coefficients within the block according to the first scanning order is the same as the position of the respective coefficient within the block according to the second scanning order, then the bitstream may include the significant coefficient flag and last significant coefficient flag data for all coefficients associated with the block, and the bitstream may lack any indication of the scanning order, i.e., the scanning order information for the block.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding coefficients associated with a block of video data during a video coding process, the method comprising:
coding information that identifies a first scanning order associated with the block if a position of any of one or more of the coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order; and
avoiding coding the information that identifies the first scanning order if the position of each of the one or more of the coefficients within the block according to the first scanning order is the same as the position of the respective coefficient within the block according to the second scanning order.

2. The method of claim 1, wherein coding comprises encoding, wherein the first scanning order and the second scanning order each comprise one of a zig-zag scanning order and a horizontal scanning order originating at a common position within the block, and wherein encoding the information that identifies the first scanning order if the position of any of the one or more of the coefficients within the block according to the first scanning order is different than the position of the respective coefficient within the block according to the second scanning order comprises:
determining whether the position of the last non-zero coefficient within the block according to the first scanning order corresponds to the common position, or to a next position within the block following the common position according to the zig-zag scanning order and the horizontal scanning order; and
in the event the position of the last non-zero coefficient within the block according to the first scanning order does not correspond to the common position or the next position, encoding an indication of whether the first scanning order is the zig-zag scanning order or the horizontal scanning order.

3. The method of claim 1, wherein coding comprises encoding, wherein the first scanning order and the second scanning order each comprise one of a diagonal scanning order and a vertical scanning order originating at a common position within the block, and wherein encoding the information that identifies the first scanning order if the position of any of the one or more of the coefficients within the block according to the first scanning order is different than the position of the respective coefficient within the block according to the second scanning order comprises:
determining whether the position of the last non-zero coefficient within the block according to the first scanning order corresponds to the common position, or to a next position within the block following the common position according to the diagonal scanning order and the vertical scanning order; and
in the event the position of the last non-zero coefficient within the block according to the first scanning order does not correspond to the common position or the next position, encoding an indication of whether the first scanning order is the diagonal scanning order or the vertical scanning order.

4. The method of claim 1, wherein coding comprises encoding, wherein the first scanning order and the second scanning order each comprise one of a zig-zag scanning order, a horizontal scanning order, and a vertical scanning order originating at a common position within the block, and wherein encoding the information that identifies the first scanning order if the position of any of the one or more of the coefficients within the block according to the first scanning order is different than the position of the respective coefficient within the block according to the second scanning order comprises:
determining whether the position of the last non-zero coefficient within the block according to the first scanning order corresponds to the common position;
in the event the position of the last non-zero coefficient within the block according to the first scanning order does not correspond to the common position, encoding an indication of whether the first scanning order is the vertical scanning order using a first signal;
in the event the first scanning order is not the vertical scanning order, determining whether the position of the last non-zero coefficient within the block according to the first scanning order corresponds to a next position within the block following the common position according to the zig-zag scanning order and the horizontal scanning order; and
in the event the position of the last non-zero coefficient within the block according to the first scanning order does not correspond to the next position, encoding an indication of whether the first scanning order is the zig-zag scanning order or the horizontal scanning order using a second signal, wherein the second signal is different than the first signal.

5. The method of claim 1, wherein coding comprises encoding, wherein the first scanning order and the second scanning order each comprise one of a diagonal scanning order, a horizontal scanning order, and a vertical scanning order originating at a common position within the block, and wherein encoding the information that identifies the first scanning order if the position of any of the one or more of the coefficients within the block according to the first scanning order is different than the position of the respective coefficient within the block according to the second scanning order comprises:
determining whether the position of the last non-zero coefficient within the block according to the first scanning order corresponds to the common position;
in the event the position of the last non-zero coefficient within the block according to the first scanning order does not correspond to the common position, encoding an indication of whether the first scanning order is the horizontal scanning order using a first signal;
in the event the first scanning order is not the horizontal scanning order, determining whether the position of the last non-zero coefficient within the block according to the first scanning order corresponds to a next position within the block following the common position according to the diagonal scanning order and the vertical scanning order; and
in the event the position of the last non-zero coefficient within the block according to the first scanning order does not correspond to the next position, encoding an indication of whether the first scanning order is the diagonal scanning order or the vertical scanning order using a second signal, wherein the second signal is different than the first signal.

6. The method of claim 1, wherein coding comprises decoding, wherein the first scanning order and the second scanning order each comprise one of a zig-zag scanning order and a horizontal scanning order originating at a common position within the block, and wherein decoding the information that identifies the first scanning order if the position of any of the one or more of the coefficients within the block according to the first scanning order is different than the position of the respective coefficient within the block according to the second scanning order comprises:
receiving a signal when the position of the last non-zero coefficient within the block according to the first scanning order does not correspond to the common position, or to a next position within the block following the common position according to the zig-zag scanning order and the horizontal scanning order; and
decoding the signal to determine whether the first scanning order is the zig-zag scanning order or the horizontal scanning order.

7. The method of claim 1, wherein coding comprises decoding, wherein the first scanning order and the second scanning order each comprise one of a diagonal scanning order and a vertical scanning order originating at a common position within the block, and wherein decoding the information that identifies the first scanning order if the position of any of the one or more of the coefficients within the block according to the first scanning order is different than the position of the respective coefficient within the block according to the second scanning order comprises:
receiving a signal when the position of the last non-zero coefficient within the block according to the first scanning order does not correspond to the common position, or to a next position within the block following the common position according to the diagonal scanning order and the vertical scanning order; and
decoding the signal to determine whether the first scanning order is the diagonal scanning order or the vertical scanning order.

8. The method of claim 1, wherein coding comprises decoding, wherein the first scanning order and the second scanning order each comprise one of a zig-zag scanning order, a horizontal scanning order, and a vertical scanning order originating at a common position within the block, and wherein decoding the information that identifies the first scanning order if the position of any of the one or more of the coefficients within the block according to the first scanning order is different than the position of the respective coefficient within the block according to the second scanning order comprises:
receiving a first signal when the position of the last non-zero coefficient within the block according to the first scanning order does not correspond to the common position;
decoding the first signal to determine whether the first scanning order is the vertical scanning order;
in the event the first scanning order is not the vertical scanning order, receiving a second signal when the position of the last non-zero coefficient within the block according to the first scanning order does not correspond to a next position within the block following the common position according to the zig-zag scanning order and the horizontal scanning order, wherein the second signal is different than the first signal; and
decoding the second signal to determine whether the first scanning order is the zig-zag scanning order or the horizontal scanning order.

9. The method of claim 1, wherein coding comprises decoding, wherein the first scanning order and the second scanning order each comprise one of a diagonal scanning order, a horizontal scanning order, and a vertical scanning order originating at a common position within the block, and wherein decoding the information that identifies the first scanning order if the position of any of the one or more of the coefficients within the block according to the first scanning order is different than the position of the respective coefficient within the block according to the second scanning order comprises:
receiving a first signal when the position of the last non-zero coefficient within the block according to the first scanning order does not correspond to the common position;
decoding the first signal to determine whether the first scanning order is the horizontal scanning order;
in the event the first scanning order is not the horizontal scanning order, receiving a second signal when the position of the last non-zero coefficient within the block according to the first scanning order does not correspond to a next position within the block following the common position according to the diagonal scanning order and the vertical scanning order, wherein the second signal is different than the first signal; and
decoding the second signal to determine whether the first scanning order is the diagonal scanning order or the vertical scanning order.

10. The method of claim 1, wherein coding the information that identifies the first scanning order associated with the block if the position of any of the one or more of the coefficients within the block according to the first scanning order is different than the position of the respective coefficient within the block according to the second scanning order comprises performing a context adaptive entropy coding process.

11. An apparatus for coding coefficients associated with a block of video data during a video coding process, the apparatus comprising a video coder configured to:
code information that identifies a first scanning order associated with the block if a position of any of one or more of the coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order; and
avoid coding the information that identifies the first scanning order if the position of each of the one or more of the coefficients within the block according to the first scanning order is the same as the position of the respective coefficient within the block according to the second scanning order.

12. The apparatus of claim 11, wherein coding comprises encoding, wherein the first scanning order and the second scanning order each comprise one of a zig-zag scanning order and a horizontal scanning order originating at a common position within the block, and wherein to encode the information that identifies the first scanning order if the position of any of the one or more of the coefficients within the block according to the first scanning order is different than the position of the respective coefficient within the block according to the second scanning order, the video coder is configured to:
determine whether the position of the last non-zero coefficient within the block according to the first scanning order corresponds to the common position, or to a next position within the block following the common position according to the zig-zag scanning order and the horizontal scanning order; and
in the event the position of the last non-zero coefficient within the block according to the first scanning order does not correspond to the common position or the next position, encode an indication of whether the first scanning order is the zig-zag scanning order or the horizontal scanning order.

13. The apparatus of claim 11, wherein coding comprises encoding, wherein the first scanning order and the second scanning order each comprise one of a diagonal scanning order and a vertical scanning order originating at a common position within the block, and wherein to encode the information that identifies the first scanning order if the position of any of the one or more of the coefficients within the block according to the first scanning order is different than the position of the respective coefficient within the block according to the second scanning order, the video coder is configured to:
determine whether the position of the last non-zero coefficient within the block according to the first scanning order corresponds to the common position, or to a next position within the block following the common position according to the diagonal scanning order and the vertical scanning order; and
in the event the position of the last non-zero coefficient within the block according to the first scanning order does not correspond to the common position or the next position, encode an indication of whether the first scanning order is the diagonal scanning order or the vertical scanning order.

14. The apparatus of claim 11, wherein coding comprises encoding, wherein the first scanning order and the second scanning order each comprise one of a zig-zag scanning order, a horizontal scanning order, and a vertical scanning order originating at a common position within the block, and wherein to encode the information that identifies the first scanning order if the position of any of the one or more of the coefficients within the block according to the first scanning order is different than the position of the respective coefficient within the block according to the second scanning order, the video coder is configured to:
determine whether the position of the last non-zero coefficient within the block according to the first scanning order corresponds to the common position;
in the event the position of the last non-zero coefficient within the block according to the first scanning order does not correspond to the common position, encode an indication of whether the first scanning order is the vertical scanning order using a first signal;
in the event the first scanning order is not the vertical scanning order, determine whether the position of the last non-zero coefficient within the block according to the first scanning order corresponds to a next position within the block following the common position according to the zig-zag scanning order and the horizontal scanning order; and
in the event the position of the last non-zero coefficient within the block according to the first scanning order does not correspond to the next position, encode an indication of whether the first scanning order is the zig-zag scanning order or the horizontal scanning order using a second signal, wherein the second signal is different than the first signal.

15. The apparatus of claim 11, wherein coding comprises encoding, wherein the first scanning order and the second scanning order each comprise one of a diagonal scanning order, a horizontal scanning order, and a vertical scanning order originating at a common position within the block, and wherein to encode the information that identifies the first scanning order if the position of any of the one or more of the coefficients within the block according to the first scanning order is different than the position of the respective coefficient within the block according to the second scanning order, the video coder is configured to:
determine whether the position of the last non-zero coefficient within the block according to the first scanning order corresponds to the common position;
in the event the position of the last non-zero coefficient within the block according to the first scanning order does not correspond to the common position, encode an indication of whether the first scanning order is the horizontal scanning order using a first signal;
in the event the first scanning order is not the horizontal scanning order, determine whether the position of the last non-zero coefficient within the block according to the first scanning order corresponds to a next position within the block following the common position according to the diagonal scanning order and the vertical scanning order; and
in the event the position of the last non-zero coefficient within the block according to the first scanning order does not correspond to the next position, encode an indication of whether the first scanning order is the diagonal scanning order or the vertical scanning order using a second signal, wherein the second signal is different than the first signal.

16. The apparatus of claim 11, wherein coding comprises decoding, wherein the first scanning order and the second scanning order each comprise one of a zig-zag scanning order and a horizontal scanning order originating at a common position within the block, and wherein to decode the information that identifies the first scanning order if the position of any of the one or more of the coefficients within the block according to the first scanning order is different than the position of the respective coefficient within the block according to the second scanning order, the video coder is configured to:
receive a signal when the position of the last non-zero coefficient within the block according to the first scanning order does not correspond to the common position, or to a next position within the block following the common position according to the zig-zag scanning order and the horizontal scanning order; and
decode the signal to determine whether the first scanning order is the zig-zag scanning order or the horizontal scanning order.

17. The apparatus of claim 11, wherein coding comprises decoding, wherein the first scanning order and the second scanning order each comprise one of a diagonal scanning order and a vertical scanning order originating at a common position within the block, and wherein to decode the information that identifies the first scanning order if the position of any of the one or more of the coefficients within the block according to the first scanning order is different than the position of the respective coefficient within the block according to the second scanning order, the video coder is configured to:
receive a signal when the position of the last non-zero coefficient within the block according to the first scanning order does not correspond to the common position, or to a next position within the block following the common position according to the diagonal scanning order and the vertical scanning order; and
decode the signal to determine whether the first scanning order is the diagonal scanning order or the vertical scanning order.

18. The apparatus of claim 11, wherein coding comprises decoding, wherein the first scanning order and the second scanning order each comprise one of a zig-zag scanning order, a horizontal scanning order, and a vertical scanning order originating at a common position within the block, and wherein to decode the information that identifies the first scanning order if the position of any of the one or more of the coefficients within the block according to the first scanning order is different than the position of the respective coefficient within the block according to the second scanning order, the video coder is configured to:
receive a first signal when the position of the last non-zero coefficient within the block according to the first scanning order does not correspond to the common position;
decode the first signal to determine whether the first scanning order is the vertical scanning order;
in the event the first scanning order is not the vertical scanning order, receive a second signal when the position of the last non-zero coefficient within the block according to the first scanning order does not correspond to a next position within the block following the common position according to the zig-zag scanning order and the horizontal scanning order, wherein the second signal is different than the first signal; and
decode the second signal to determine whether the first scanning order is the zig-zag scanning order or the horizontal scanning order.

19. The apparatus of claim 11, wherein coding comprises decoding, wherein the first scanning order and the second scanning order each comprise one of a diagonal scanning order, a horizontal scanning order, and a vertical scanning order originating at a common position within the block, and wherein to decode the information that identifies the first scanning order if the position of any of the one or more of the coefficients within the block according to the first scanning order is different than the position of the respective coefficient within the block according to the second scanning order, the video coder is configured to:
receive a first signal when the position of the last non-zero coefficient within the block according to the first scanning order does not correspond to the common position;
decode the first signal to determine whether the first scanning order is the horizontal scanning order;
in the event the first scanning order is not the horizontal scanning order, receive a second signal when the position of the last non-zero coefficient within the block according to the first scanning order does not correspond to a next position within the block following the common position according to the diagonal scanning order and the vertical scanning order, wherein the second signal is different than the first signal; and
decode the second signal to determine whether the first scanning order is the diagonal scanning order or the vertical scanning order.

20. The apparatus of claim 11, wherein to code the information that identifies the first scanning order associated with the block if the position of any of the one or more of the coefficients within the block according to the first scanning order is different than the position of the respective coefficient within the block according to the second scanning order, the video coder is configured to perform a context adaptive entropy coding process.

21. The apparatus of claim 11, wherein the apparatus comprises at least one of:
an integrated circuit;
a microprocessor; and
a wireless communication device that includes the video coder.

22. A device for coding coefficients associated with a block of video data during a video coding process, the device comprising:
means for coding information that identifies a first scanning order associated with the block if a position of any of one or more of the coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order; and
means for avoiding coding the information that identifies the first scanning order if the position of each of the one or more of the coefficients within the block according to the first scanning order is the same as the position of the respective coefficient within the block according to the second scanning order.

23. The device of claim 22, wherein coding comprises encoding, wherein the first scanning order and the second scanning order each comprise one of a zig-zag scanning order and a horizontal scanning order originating at a common position within the block, and wherein the means for encoding the information that identifies the first scanning order if the position of any of the one or more of the coefficients within the block according to the first scanning order is different than the position of the respective coefficient within the block according to the second scanning order comprises:
means for determining whether the position of the last non-zero coefficient within the block according to the first scanning order corresponds to the common position, or to a next position within the block following the common position according to the zig-zag scanning order and the horizontal scanning order; and
means for, in the event the position of the last non-zero coefficient within the block according to the first scanning order does not correspond to the common position or the next position, encoding an indication of whether the first scanning order is the zig-zag scanning order or the horizontal scanning order.

24. The device of claim 22, wherein coding comprises encoding, wherein the first scanning order and the second scanning order each comprise one of a diagonal scanning order and a vertical scanning order originating at a common position within the block, and wherein the means for encoding the information that identifies the first scanning order if the position of any of the one or more of the coefficients within the block according to the first scanning order is different than the position of the respective coefficient within the block according to the second scanning order comprises:
means for determining whether the position of the last non-zero coefficient within the block according to the first scanning order corresponds to the common position, or to a next position within the block following the common position according to the diagonal scanning order and the vertical scanning order; and
means for, in the event the position of the last non-zero coefficient within the block according to the first scanning order does not correspond to the common position or the next position, encoding an indication of whether the first scanning order is the diagonal scanning order or the vertical scanning order.

25. The device of claim 22, wherein coding comprises encoding, wherein the first scanning order and the second scanning order each comprise one of a zig-zag scanning order, a horizontal scanning order, and a vertical scanning order originating at a common position within the block, and wherein the means for encoding the information that identifies the first scanning order if the position of any of the one or more of the coefficients within the block according to the first scanning order is different than the position of the respective coefficient within the block according to the second scanning order comprises:
means for determining whether the position of the last non-zero coefficient within the block according to the first scanning order corresponds to the common position;
means for, in the event the position of the last non-zero coefficient within the block according to the first scanning order does not correspond to the common position, encoding an indication of whether the first scanning order is the vertical scanning order using a first signal;
means for, in the event the first scanning order is not the vertical scanning order, determining whether the position of the last non-zero coefficient within the block according to the first scanning order corresponds to a next position within the block following the common position according to the zig-zag scanning order and the horizontal scanning order; and
means for, in the event the position of the last non-zero coefficient within the block according to the first scanning order does not correspond to the next position, encoding an indication of whether the first scanning order is the zig-zag scanning order or the horizontal scanning order using a second signal, wherein the second signal is different than the first signal.

26. The device of claim 22, wherein coding comprises encoding, wherein the first scanning order and the second scanning order each comprise one of a diagonal scanning order, a horizontal scanning order, and a vertical scanning order originating at a common position within the block, and wherein the means for encoding the information that identifies the first scanning order if the position of any of the one or more of the coefficients within the block according to the first scanning order is different than the position of the respective coefficient within the block according to the second scanning order comprises:
means for determining whether the position of the last non-zero coefficient within the block according to the first scanning order corresponds to the common position;
means for, in the event the position of the last non-zero coefficient within the block according to the first scanning order does not correspond to the common position, encoding an indication of whether the first scanning order is the horizontal scanning order using a first signal;
means for, in the event the first scanning order is not the horizontal scanning order, determining whether the position of the last non-zero coefficient within the block according to the first scanning order corresponds to a next position within the block following the common position according to the diagonal scanning order and the vertical scanning order; and
means for, in the event the position of the last non-zero coefficient within the block according to the first scanning order does not correspond to the next position, encoding an indication of whether the first scanning order is the diagonal scanning order or the vertical scanning order using a second signal, wherein the second signal is different than the first signal.

27. The device of claim 22, wherein coding comprises decoding, wherein the first scanning order and the second scanning order each comprise one of a zig-zag scanning order and a horizontal scanning order originating at a common position within the block, and wherein the means for decoding the information that identifies the first scanning order if the position of any of the one or more of the coefficients within the block according to the first scanning order is different than the position of the respective coefficient within the block according to the second scanning order comprises:
means for receiving a signal when the position of the last non-zero coefficient within the block according to the first scanning order does not correspond to the common position, or to a next position within the block following the common position according to the zig-zag scanning order and the horizontal scanning order; and
means for decoding the signal to determine whether the first scanning order is the zig-zag scanning order or the horizontal scanning order.

28. The device of claim 22, wherein coding comprises decoding, wherein the first scanning order and the second scanning order each comprise one of a diagonal scanning order and a vertical scanning order originating at a common position within the block, and wherein the means for decoding the information that identifies the first scanning order if the position of any of the one or more of the coefficients within the block according to the first scanning order is different than the position of the respective coefficient within the block according to the second scanning order comprises:
means for receiving a signal when the position of the last non-zero coefficient within the block according to the first scanning order does not correspond to the common position, or to a next position within the block following the common position according to the diagonal scanning order and the vertical scanning order; and
means for decoding the signal to determine whether the first scanning order is the diagonal scanning order or the vertical scanning order.

29. The device of claim 22, wherein coding comprises decoding, wherein the first scanning order and the second scanning order each comprise one of a zig-zag scanning order, a horizontal scanning order, and a vertical scanning order originating at a common position within the block, and wherein the means for decoding the information that identifies the first scanning order if the position of any of the one or more of the coefficients within the block according to the first scanning order is different than the position of the respective coefficient within the block according to the second scanning order comprises:
means for receiving a first signal when the position of the last non-zero coefficient within the block according to the first scanning order does not correspond to the common position;
means for decoding the first signal to determine whether the first scanning order is the vertical scanning order;
means for, in the event the first scanning order is not the vertical scanning order, receiving a second signal when the position of the last non-zero coefficient within the block according to the first scanning order does not correspond to a next position within the block following the common position according to the zig-zag scanning order and the horizontal scanning order, wherein the second signal is different than the first signal; and
means for decoding the second signal to determine whether the first scanning order is the zig-zag scanning order or the horizontal scanning order.

30. The device of claim 22, wherein coding comprises decoding, wherein the first scanning order and the second scanning order each comprise one of a diagonal scanning order, a horizontal scanning order, and a vertical scanning order originating at a common position within the block, and wherein the means for decoding the information that identifies the first scanning order if the position of any of the one or more of the coefficients within the block according to the first scanning order is different than the position of the respective coefficient within the block according to the second scanning order comprises:
means for receiving a first signal when the position of the last non-zero coefficient within the block according to the first scanning order does not correspond to the common position;
means for decoding the first signal to determine whether the first scanning order is the horizontal scanning order;
means for, in the event the first scanning order is not the horizontal scanning order, receiving a second signal when the position of the last non-zero coefficient within the block according to the first scanning order does not correspond to a next position within the block following the common position according to the diagonal scanning order and the vertical scanning order, wherein the second signal is different than the first signal; and
means for decoding the second signal to determine whether the first scanning order is the diagonal scanning order or the vertical scanning order.

31. The device of claim 22, wherein the means for coding the information that identifies the first scanning order associated with the block if the position of any of the one or more of the coefficients within the block according to the first scanning order is different than the position of the respective coefficient within the block according to the second scanning order comprise means for performing a context adaptive entropy coding process.

32. A computer-readable medium comprising instructions that, when executed, cause a processor to code coefficients associated with a block of video data during a video coding process, wherein the instructions cause the processor to:
code information that identifies a first scanning order associated with the block if a position of any of one or more of the coefficients within the block, starting with a first coefficient within the block according to the first scanning order and ending with a last non-zero coefficient within the block according to the first scanning order, and proceeding according to the first scanning order, according to the first scanning order is different than a position of the respective coefficient within the block according to a second scanning order, wherein the second scanning order is different than the first scanning order; and
avoid coding the information that identifies the first scanning order if the position of each of the one or more of the coefficients within the block according to the first scanning order is the same as the position of the respective coefficient within the block according to the second scanning order.

33. The computer-readable medium of claim 32, wherein coding comprises encoding, wherein the first scanning order and the second scanning order each comprise one of a zig-zag scanning order and a horizontal scanning order originating at a common position within the block, and wherein the instructions that cause the processor to encode the information that identifies the first scanning order if the position of any of the one or more of the coefficients within the block according to the first scanning order is different than the position of the respective coefficient within the block according to the second scanning order comprise instructions that cause the processor to:
determine whether the position of the last non-zero coefficient within the block according to the first scanning order corresponds to the common position, or to a next position within the block following the common position according to the zig-zag scanning order and the horizontal scanning order; and
in the event the position of the last non-zero coefficient within the block according to the first scanning order does not correspond to the common position or the next position, encode an indication of whether the first scanning order is the zig-zag scanning order or the horizontal scanning order.

34. The computer-readable medium of claim 32, wherein coding comprises encoding, wherein the first scanning order and the second scanning order each comprise one of a diagonal scanning order and a vertical scanning order originating at a common position within the block, and wherein the instructions that cause the processor to encode the information that identifies the first scanning order if the position of any of the one or more of the coefficients within the block according to the first scanning order is different than the position of the respective coefficient within the block according to the second scanning order comprise instructions that cause the processor to:
determine whether the position of the last non-zero coefficient within the block according to the first scanning order corresponds to the common position, or to a next position within the block following the common position according to the diagonal scanning order and the vertical scanning order; and
in the event the position of the last non-zero coefficient within the block according to the first scanning order does not correspond to the common position or the next position, encode an indication of whether the first scanning order is the diagonal scanning order or the vertical scanning order.

35. The computer-readable medium of claim 32, wherein coding comprises encoding, wherein the first scanning order and the second scanning order each comprise one of a zig-zag scanning order, a horizontal scanning order, and a vertical scanning order originating at a common position within the block, and wherein the instructions that cause the processor to encode the information that identifies the first scanning order if the position of any of the one or more of the coefficients within the block according to the first scanning order is different than the position of the respective coefficient within the block according to the second scanning order comprise instructions that cause the processor to:
determine whether the position of the last non-zero coefficient within the block according to the first scanning order corresponds to the common position;
in the event the position of the last non-zero coefficient within the block according to the first scanning order does not correspond to the common position, encode an indication of whether the first scanning order is the vertical scanning order using a first signal;
in the event the first scanning order is not the vertical scanning order, determine whether the position of the last non-zero coefficient within the block according to the first scanning order corresponds to a next position within the block following the common position according to the zig-zag scanning order and the horizontal scanning order; and
in the event the position of the last non-zero coefficient within the block according to the first scanning order does not correspond to the next position, encode an indication of whether the first scanning order is the zig-zag scanning order or the horizontal scanning order using a second signal, wherein the second signal is different than the first signal.

36. The computer-readable medium of claim 32, wherein coding comprises encoding, wherein the first scanning order and the second scanning order each comprise one of a diagonal scanning order, a horizontal scanning order, and a vertical scanning order originating at a common position within the block, and wherein the instructions that cause the processor to encode the information that identifies the first scanning order if the position of any of the one or more of the coefficients within the block according to the first scanning order is different than the position of the respective coefficient within the block according to the second scanning order comprise instructions that cause the processor to:
determine whether the position of the last non-zero coefficient within the block according to the first scanning order corresponds to the common position;
in the event the position of the last non-zero coefficient within the block according to the first scanning order does not correspond to the common position, encode an indication of whether the first scanning order is the horizontal scanning order using a first signal;
in the event the first scanning order is not the horizontal scanning order, determine whether the position of the last non-zero coefficient within the block according to the first scanning order corresponds to a next position within the block following the common position according to the diagonal scanning order and the vertical scanning order; and
in the event the position of the last non-zero coefficient within the block according to the first scanning order does not correspond to the next position, encode an indication of whether the first scanning order is the diagonal scanning order or the vertical scanning order using a second signal, wherein the second signal is different than the first signal.

37. The computer-readable medium of claim 32, wherein coding comprises decoding, wherein the first scanning order and the second scanning order each comprise one of a zig-zag scanning order and a horizontal scanning order originating at a common position within the block, and wherein the instructions that cause the processor to decode the information that identifies the first scanning order if the position of any of the one or more of the coefficients within the block according to the first scanning order is different than the position of the respective coefficient within the block according to the second scanning order comprise instructions that cause the processor to:
receive a signal when the position of the last non-zero coefficient within the block according to the first scanning order does not correspond to the common position, or to a next position within the block following the common position according to the zig-zag scanning order and the horizontal scanning order; and
decode the signal to determine whether the first scanning order is the zig-zag scanning order or the horizontal scanning order.

38. The computer-readable medium of claim 32, wherein coding comprises decoding, wherein the first scanning order and the second scanning order each comprise one of a diagonal scanning order and a vertical scanning order originating at a common position within the block, and wherein the instructions that cause the processor to decode the information that identifies the first scanning order if the position of any of the one or more of the coefficients within the block according to the first scanning order is different than the position of the respective coefficient within the block according to the second scanning order comprise instructions that cause the processor to:
receive a signal when the position of the last non-zero coefficient within the block according to the first scanning order does not correspond to the common position, or to a next position within the block following the common position according to the diagonal scanning order and the vertical scanning order; and
decode the signal to determine whether the first scanning order is the diagonal scanning order or the vertical scanning order.

39. The computer-readable medium of claim 32, wherein coding comprises decoding, wherein the first scanning order and the second scanning order each comprise one of a zig-zag scanning order, a horizontal scanning order, and a vertical scanning order originating at a common position within the block, and wherein the instructions that cause the processor to decode the information that identifies the first scanning order if the position of any of the one or more of the coefficients within the block according to the first scanning order is different than the position of the respective coefficient within the block according to the second scanning order comprise instructions that cause the processor to:
receive a first signal when the position of the last non-zero coefficient within the block according to the first scanning order does not correspond to the common position;
decode the first signal to determine whether the first scanning order is the vertical scanning order;
in the event the first scanning order is not the vertical scanning order, receive a second signal when the position of the last non-zero coefficient within the block according to the first scanning order does not correspond to a next position within the block following the common position according to the zig-zag scanning order and the horizontal scanning order, wherein the second signal is different than the first signal; and
decode the second signal to determine whether the first scanning order is the zig-zag scanning order or the horizontal scanning order.

40. The computer-readable medium of claim 32, wherein coding comprises decoding, wherein the first scanning order and the second scanning order each comprise one of a diagonal scanning order, a horizontal scanning order, and a vertical scanning order originating at a common position within the block, and wherein the instructions that cause the processor to decode the information that identifies the first scanning order if the position of any of the one or more of the coefficients within the block according to the first scanning order is different than the position of the respective coefficient within the block according to the second scanning order comprise instructions that cause the processor to:
receive a first signal when the position of the last non-zero coefficient within the block according to the first scanning order does not correspond to the common position;
decode the first signal to determine whether the first scanning order is the horizontal scanning order;
in the event the first scanning order is not the horizontal scanning order, receive a second signal when the position of the last non-zero coefficient within the block according to the first scanning order does not correspond to a next position within the block following the common position according to the diagonal scanning order and the vertical scanning order, wherein the second signal is different than the first signal; and
decode the second signal to determine whether the first scanning order is the diagonal scanning order or the vertical scanning order.

41. The computer-readable medium of claim 32, wherein the instructions that cause the processor to code the information that identifies the first scanning order associated with the block if the position of any of the one or more of the coefficients within the block according to the first scanning order is different than the position of the respective coefficient within the block according to the second scanning order comprise instructions that cause the processor to perform a context adaptive entropy coding process.
